(19) United States
(12) Patent Application Publication
(10) Pub. No.: US 2024/0361278 A1
(43) Pub. Date: Oct. 31, 2024

(54) ULTRASONIC WAVEGUIDE SENSOR AND APPARATUS FOR DISTRIBUTED PHYSICAL PARAMETER MEASUREMENTS

(71) Applicant: X-Wave Innovations, Inc., Gaithersburg, MD (US)

(72) Inventors: Dan Xiang, Gaithersburg, MD (US); BERKIN ULUUTKU, Gaithersburg, MD (US); MYUNG KYUN SUNG, Gaithersburg, MD (US)

(73) Assignee: X-wave Innovations, Inc., Gaithersburg, MD (US)

(21) Appl. No.: 18/648,375

(22) Filed: Apr. 27, 2024

Related U.S. Application Data
(60) Provisional application No. 63/462,291, filed on Apr. 27, 2023.

(51) Int. Cl. G01N 29/24; G01N 29/07; G01N 29/34

(52) U.S. Cl. CPC G01N 29/2462; G01N 29/07; G01N 29/348

(57) ABSTRACT

An apparatus and method for distributed physical parameter measurements of the surrounding environment is disclosed. The apparatus can include a waveguide with an elongated body configured with three gratings along the body where each of the three gratings is configured to fully or partially reflect an acoustic wave on the waveguide at a different frequency than the other gratings of the three gratings. Further, each of the three gratings can comprise discontinuities in the grating configured to reflect one or more frequencies of acoustic waves, and each of the discontinuities for each of the three gratings has an internal geometry configured according to fractions of an acoustic wave's frequency and corresponding wavelength.

### CROSS-REFERENCE TO RELATED APPLICATIONS

This application claims priority benefits under 35 U.S.C § 111(b) to U.S. Provisional Application No. 63/462,291 filed Apr. 27, 2023, which hereby incorporated by reference in its entirety.

### ACKNOWLEDGMENT OF GOVERNMENT SUPPORT

This invention was made with government support under DE-SC0022826 awarded by the U.S. Department of Energy. The government has certain rights in the invention.

### FIELD OF INVENTION

The present invention is in the technical field of sensor and sensor systems. More particularly, the present invention is in the field of an ultrasonic waveguide sensor and apparatus for sensing distributed physical parameters, including but not limited to multi-point temperatures, temperature profiles, and fluid levels.

### BACKGROUND

Sensors play a vital part in ensuring a process is running to its design specification and highlighting any undesired conditions, which can then be minimized if not avoidable. Advanced nuclear reactors require advanced, innovative sensors which can assist in monitoring critical and non-critical operations. The challenges posed by advanced reactors are more rigorous than those posed by conventional nuclear reactors and are several magnitudes higher than those of non-nuclear-based power generation systems. While sensors designed for light water reactors (LWR) need to operate at temperatures of 300° C., the operating temperature in advanced reactors reaches as high as 700° C. to 1000° C. The operational temperature can rise even higher in test reactors to approximately 2800° C. In addition, sensors in advanced nuclear reactors must withstand exposure to corrosive materials, such as molten fluoride salts and liquid metals, and they must exhibit tolerance to irradiation. In addition to these environmental effects, it is desirable for a single sensor to obtain multiple measurements, as the space for sensor installation in and around nuclear reactors is severely limited.

Ultrasonic waveguides confine and direct ultrasonic waves along a specific path. They play a critical role in improving the resolution, sensitivity, and accuracy of ultrasound-based techniques, making them an essential component of many ultrasound systems. Ultrasonic waveguides are widely used in a variety of applications, such as sensors and non-destructive testing. Different ultrasonic waveguides make ultrasonic wave propagation in those geometries important problems for applications. Therefore, the theory and acoustic wave propagation in common waveguide geometries is extensively investigated in the literature. Among different types of ultrasound waveguides, plate, and cylindrical waveguides are particularly common. Plate waveguides are thin and flat structures that guide ultrasound waves along their surface, while cylindrical waveguides are tubular. In engineering applications, the solid cylinder is one of the most common mechanical waveguides.

In solid cylinders, there are three families of modes: longitudinal, torsional, and flexural. Flexural waves qualitatively resemble antisymmetric modes in a plate. The fundamental flexural mode has no cutoff frequency and propagates down to zero frequency, while higher modes have cutoffs and are dispersive. For cylindrical coordinates in propagation, the motion of flexural waves depends on all spatial components; r, θ, and z. Therefore, flexural waves are generally regarded as the most complicated type of waves on a cylinder. Torsional waves have only one displacement component in the θ direction. Similar to flexural waves, the fundamental mode has no cutoff frequency and propagates down to zero frequency, while higher modes have cutoffs and are dispersive. In addition, the fundamental mode has a constant velocity of √μ/ρ. Finally, in the longitudinal (also referred to as compressional) wavemodes, the displacement is independent of θ. In this work, we will utilize longitudinal wave modes, and in this section, we will mainly focus on longitudinal wave modes. Detailed analytical derivations on these three wavemodes can be found in the reference.

The analytical solution for longitudinal wave propagation in a cylindrical waveguide is given by the Pochhammer-Chree equations:

$$\frac{2 α}{r} ( {β}^{2} + {k}^{2} ) {J}_{1} ( α r ) {J}_{1} ( β r ) - ( {β}^{2} - {k}^{2} ) {J}_{0} ( α r ) {J}_{1} ( β r ) - 4 {k}^{2} αβ {J}_{1} ( α r ) {J}_{0} ( β r ) = 0 \\ ( β r ) {J}_{0} ( β r ) - 2 {J}_{1} ( β r ) = 0$$

$$where$$

$${α}^{2} = {( \frac{ω}{{c}_{L}} )}^{2} - {k}^{2} \\ {β}^{2} = {( \frac{ω}{{c}_{T}} )}^{2} - {k}^{2}$$

This these formulas, r is the radius of the rod, k is the wavenumber, c_{T} and c_{L} are the velocity of torsional and longitudinal waves, and J₀ and J₁ are Bessel functions of the first kind. The Pochhammer-Chree equations are solved numerically to determine the phase velocity, resulting in dispersion curves that vary with frequency. Using the phase velocity and wavenumber, the group velocity is calculated, which represents the speed at which a wave packet or carrier signal travels, especially in the case of a pulsed signal. It is important to note that the group and phase velocities may not be identical, and since acoustic signals usually have complex frequency content, different components of the wave packet may propagate at slightly varying velocities, causing the wave packet to spread gradually. This phenomenon is referred to as dispersion. Representative dispersion curves for steel and aluminum wires can be found in the graphs below. In the graphs, dispersion for longitudinal, flexural and torsional waves is shown. The frequency axis of the dispersion curve scales proportionally with the radius of the rod. This means using a rod with a larger radius will make higher-order modes appear in lower frequencies. Likewise, using a thinner rod, the higher order modes can be avoided in low frequencies. The ratio of the group and the phase velocity determines the dispersiveness of the wave. When the ratio is equal to or closes to 1, the wave is considered non-dispersive in the given frequency.

Acoustic wave manipulation has been a topic of great interest in the field of acoustics due to its potential to revolutionize various applications, such as communication systems and sensing technologies. Recent advances in this field have led to the development of innovative techniques for generating bandstop filters in cylindrical circular rod waveguides by incorporating isotropic periodic geometries. FIG. 29 provides an illustration of this concept. These geometries are created by introducing periodic gratings to the material, which result in the formation of bandgaps in the dispersion. The graph shows that these bandgaps are expected to act as bandstop filters for the frequency range of the bandgap, which can be used for various applications. For instance, the bandstop filters can be used to create frequency-selective reflectors that reflect certain frequencies while allowing others to pass through. This can be utilized for various communication systems and sensory applications that require selective filtering of certain frequencies.

Temperature is a crucial parameter in many physical processes and engineering applications as it can both drive a process or pose a hazard. Therefore, precise temperature measurement and control are essential in many fields, including manufacturing, medical, and environmental monitoring. Several methods exist for temperature measurements, including thermocouples, resistive temperature measurement devices (RTD), and ultrasonic temperature sensing (UTS). UTS has gained popularity due to its non-invasive nature and the ability to perform measurements in harsh environments or difficult-to-reach areas. In UTS, the temperature of the environment or material is determined by measuring the speed of sound. An ultrasonic transducer generates a narrow, broadband pulse. The generated pulse is recorded with another ultrasonic sensor, or the reflections/echoes of this pulse are captured with the ultrasonic generating sensor. By measuring the travel time of the pulse (time-of-flight) over a predetermined known distance, the speed of sound in the environment is determined and correlated to the temperature. In order to protect the sensor from harsh environments or obtain measurements from difficult-to-reach areas, a waveguide-based approach is often employed. This approach uses a waveguide attached to the sensor to interact with the environment, and the generated pulse travels through the waveguide. The pulse can be partially reflected by discontinuities, such as notches, gratings, diameter changes, and the end of the waveguide. These reflections create time differences over known lengths, from which the speed of sound and temperature for the section can be correlated. UTS offers a non-invasive and reliable method for temperature measurement in harsh environments or difficult-to-reach areas. FIG. 30 illustrates a typical UTS using a pulse/echo along a waveguide. The waveguide-based approach provides additional protection for the sensor while allowing for accurate temperature measurements. As the temperature sensor market continues to grow, UTS is likely to play an increasingly important role in temperature measurement and control in various industries.

Temperature sensing is of the utmost importance in nuclear power plants, where the accurate measurement of temperatures is essential for ensuring safe and efficient operation. However, in nuclear power plant applications, traditional temperature sensing methods, such as thermocouples, thermistors, and RTDs, are limited by their need for direct contact with the measured environment. The hazardous environment of a nuclear reactor can lead to reliability issues and damage to the sensory devices. For example, RTD may drift significantly during high temperature, long duration operations. UTS, on the other hand, can be placed in remote locations and perform non-intrusive measurements by utilizing waveguides to interact with the point/region of interest. The waveguides are significantly cheaper and more resilient than active sensor components, which allows them to be exposed to harsh environments while protecting the sensor components. The high-temperature capabilities and environmental resilience of UTS make them an ideal choice for nuclear reactor operations, where temperatures can reach extreme levels. UTS have been reported to operate in temperatures as high as 2800-3100° C., which is much higher than the operating temperature range of traditional temperature sensing methods. The applications of UTS in nuclear reactor operations are diverse, with early demonstrations dating back to the 1970s. Some of the common applications of UTS in nuclear reactors are measuring fuel line, reactor coolant and liquid sodium/metal heat exchanger temperatures. Real-time temperature monitoring of these systems is essential for maintaining the integrity and safety of the nuclear reactor.

In some applications, single-point temperature measurements may not provide sufficient information about a system's thermal behavior, and the system's temperature profile is required. To address this need, researchers have developed ultrasonic multi-point temperature sensors that enable simultaneous temperature measurements at multiple points along a waveguide. The basic concept of an ultrasonic multipoint temperature sensor involves the use of multiple discontinuities along a waveguide, which act as reflectors to divide the waveguide into sections. The time-of-flight (TOF) for each section is measured to determine the temperature of each section. Various geometries of waveguides have been utilized for ultrasonic multi-point temperature sensor applications in the literature. These include the straight rod illustrated in FIG. 32 of L-shaped bent rods, helical wires, and more.

The main idea of the current state-of-the-art ultrasonic temperature measurement can be summarized as follows: The ultrasonic pulse travels through the waveguide, where a fraction of the pulse energy is reflected at each discontinuity, which is a geometric feature such as a notch or a change in diameter. The reflected pulses are received by the transducer, which converts them into electrical signals. These signals are amplified and then evaluated in a start/stop counter system. The time interval between two adjacent echoes is evaluated and compared to a calibration curve to determine the average temperature in the corresponding sensor segment. By incorporating multiple notches along the sensor wire, the system can measure temperature profiles along the wire and provide access to the thermal state of the object under test. FIG. 31 displays a schematic representation of a prior multi-sensor ultrasonic testing system.

L-shaped bent and helical waveguides for temperature measurements are presented in Periyannan et al.'s work. In their work, Periyannan et al. describe the development and application of an ultrasonic spiral waveguide temperature sensor for distributed temperature measurements on a plane. The authors used Finite Element simulation to design the waveguide and calibrated it using time of flight (TOF) changes from guided ultrasonic modes L(0,1) and T(0,1) with uniformly varying temperatures. The chromel spiral waveguide contained four pairs of notches, and the time of flight distances between the notches was used to calculate the average temperature of the corresponding waveguide section. Their waveguide and experimental setup can be found in FIG. 15. The main idea behind the L-shaped waveguide is quite different and closer to the combination of multiple single-point sensors. The presented L-shaped waveguide contains a 90° bent that creates a discontinuity and causes some portion of the acoustic energy to reflect back to the transducer. The transmitted part of the acoustic energy travels to the end of the waveguide and then reflects back to the transducer. Time of flight difference between the reflection from the elbow and the end of the waveguide results in the average temperature of the bent part of the waveguide. Assumption of an isothermal environment in x and y directions may allow one to argue this method yields point-wise temperature measurements in the z-direction. As one can notice from the description, one waveguide yields only a single temperature measurement. However, the authors attach more waveguides to their ultrasonic transducer to measure more points.

However, despite the differences in waveguide geometry, discontinuities are generated using notches or bends that partially reflect the ultrasonic pulse and allow TOF measurements. Therefore, these methods suffer from similar drawbacks. First, time of flight measurements only provides the average temperature of an entire section of the waveguide, hence reflection between two points. Therefore, the measurement accuracy is significantly affected when there is a temperature gradient or spatial distribution of temperature. To increase the accuracy of the measurement, the measured section needs to be as small as possible. However, acoustic reflections from multiple reflectors that are very close to each other are extremely difficult to reliably decompose and distinguish. Furthermore, the presence of other wavemodes, and higher-order reflections increases the challenge significantly. For example, When some of the notches are emerged in the fluid, their corresponding reflection signals change while other reflection signals from notches above the fluid level remain the same.

### SUMMARY

What is needed, then, is a novel waveguide, waveguide sensor, and apparatus for distributed physical parameter measurements that overcomes the shortcomings of the prior devices and methods. The problems and shortcomings of traditional devices can be overcome by the present embodiments for an ultrasonic sensor system, which can include an ultrasonic waveguide, an adaptor, a transducer, an interrogator (or ultrasonic transmitter and receiver), signal processing algorithms, and application software with a graphic user interface (GUI).

In an embodiment, an apparatus for distributed physical parameter measurements of the surrounding environment is disclosed. The apparatus can include a waveguide with an elongated body configured with three gratings along the body where each of the three gratings is configured to fully or partially reflect an acoustic wave on the waveguide at a different frequency than the other gratings of the three gratings. Further, each of the three gratings can comprise discontinuities in the grating configured to reflect one or more frequencies of acoustic waves, and each of the discontinuities for each of the three gratings has an internal geometry configured according to fractions of an acoustic wave's frequency and corresponding wavelength.

### BRIEF DESCRIPTION OF THE DRAWINGS

The present embodiments are better understood by reference to the following detailed description when considered in connection with the accompanying drawing, wherein:

FIG. 1 is a schematic of an ultrasonic multi-point temperature sensor (UMTS) system of the embodiments;

FIG. 2 is a schematic illustration of frequency-selective reflection from a grating structure according to the embodiments;

FIG. 3 illustrates a 3D model and cross-section of a waveguide with 3-cut grating according to the embodiments;

FIG. 4 illustrates a plot of finite elements analysis simulated reflection signals from a grating at elevated temperatures according to the embodiments;

FIG. 5 is a plot of frequency analysis of FEA simulated grating reflection signals at elevated temperatures according to the embodiments;

FIG. 6 illustrates plots of correlations between the temperatures and extracted features from the FEA simulated grating reflecting signals according to the embodiments;

FIG. 7 illustrates an exemplary waveguide configured for multi-point measurements;

FIG. 8 illustrates plots of results for different spacing and input signals with 1 MHz assigned for both cases of the waveguide of FIG. 7;

FIG. 9 illustrates FEA results for various signals and temperatures of the waveguide of FIG. 7;

FIG. 10 illustrates FFT analysis for notch sets under different input signals from FIG. 9 of the waveguide of FIG. 7;

FIG. 11 is a 3D model of an exemplary ultrasonic adapter and waveguide;

FIG. 12 illustrates a side view of the exemplary conical horn adapter and elongated waveguide used for testing with exemplary dimensions in millimeters;

FIG. 13 is a 3D model of an exemplary assembly focusing on a waveguide ultrasonic adapter connection;

FIG. 14 is a 3D model of an exemplary waveguide sensor and transducer according to the embodiments;

FIG. 15 illustrates an exemplary waveguide for single point temperature experiment with UMTS embodiments;

FIG. 16 illustrates a plot of the FFT of the grating of the reflection signal from the test using the waveguide of FIG. 15;

FIG. 17 illustrates plots of temperature vs. reflected frequency center and Q factor for the single point temperature experiment of FIGS. 16 and 17;

FIG. 18 illustrates a plot of temperature vs. reflected amplitude for the single point temperature experiment of FIGS. 16 and 17;

FIG. 19 is an exemplary waveguide for the single point temperature experiment designed for a 3 MHz signal;

FIG. 20 illustrates plots of temperature vs. reflected amplitude center and Q factor for experiments with the waveguide of FIG. 19;

FIG. 21 illustrates a plot of temperature vs. reflected frequency for the test targeting 1 MHz using the waveguide of FIG. 19;

FIG. 22 is a schematic of an exemplary waveguide for the two-point temperature experiment designed with two 1 MHz gratings;

FIG. 23 illustrates plots of temperature vs. reflected frequency from two 1 MHz gratings on the same exemplary waveguide;

FIG. 24 illustrates plots of temperature vs. reflected frequency from 1 MHz and 3 MHz gratings on the same exemplary waveguide;

FIG. 25 illustrates plots for temperature vs. reflected frequency from 3 MHz and 1 MHz gratings on the same waveguide;

FIG. 26 illustrates a schematic for the two-point temperature experiment with three different gratings on an exemplary waveguide;

FIG. 27 illustrates plots of temperature vs. reflected frequency from A) first grating (3 MHz), B) second grating (1 MHz), and C) third grating (300 kHz) using the waveguide of FIG. 26;

FIG. 28 illustrates the principle of an ultrasonic waveguide sensor of the embodiments for fluid level measurement based on changes in detected reflection signals from gratings in the waveguide;

FIG. 29 is a prior waveguide for generating bandstop filters in cylindrical circular rod by incorporating isotropic periodic geometries;

FIG. 30 illustrates a typical UTS using a pulse/echo along a waveguide;

FIG. 31 is a schematic representation of a prior multi-sensor ultrasonic testing system;

FIG. 32 are images of examples of typical UTS shapes of helical wires; and

FIG. 33 is a diagram of a basic block diagram showing a center line and a Block-Floquet boundary line; and

FIG. 34 is a flowchart of an exemplary method of the embodiments.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. The present disclosure is to be considered as an exemplification of the invention and is not intended to limit the invention to the specific embodiments illustrated by the figures or description herein.

Various embodiments of the present invention may incorporate one or more of these and the other features described herein. The following detailed description taken in conjunction with the accompanying drawings may provide a better understanding of the nature and advantages of the present invention. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications. While the invention has been described with a certain degree of particularity, it is manifest that many changes may be made in detail of construction and the arrangement of components without departing from the spirit and scope of this disclosure. The present disclosure is to be considered as an exemplification of the principles of the invention and is not intended to limit the invention to the specific embodiments illustrated herein by the figures or description above.

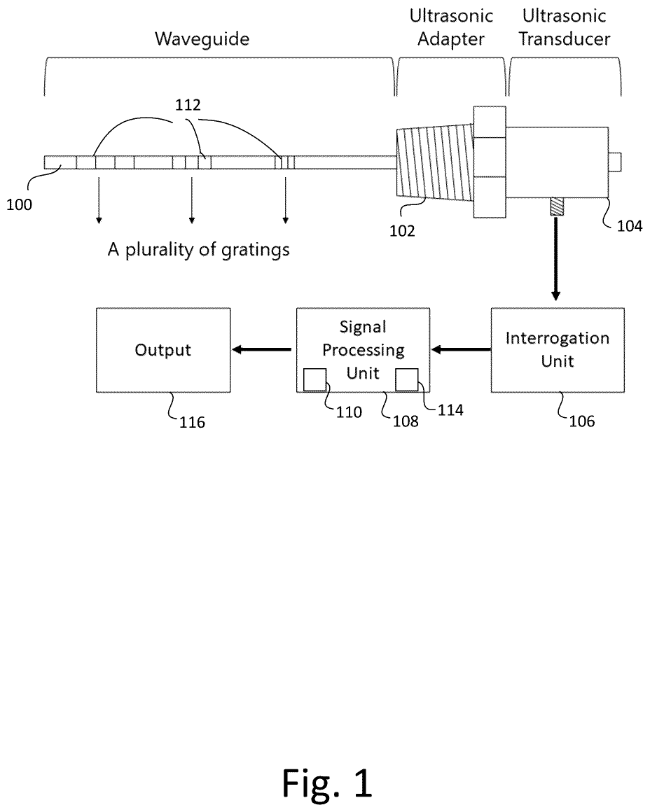

FIG. 1 is a schematic of an embodiment for an ultrasonic multi-point temperature sensor (UMTS) system. The present embodiments for an ultrasonic multi-point temperature sensor system can include an ultrasonic waveguide 100. The waveguide 100 can connect or operationally connect to an ultrasonic adaptor 102, which can connect to an ultrasonic transducer 104. An interrogation unit 106 (or alternatively in other embodiments an ultrasonic transmitter and receiver) can operationally connect to the transducer 104 and operationally connect to a signal processing unit 108. The interrogation unit 106 can be connected to the transducer 104 for facilitation of electrical/acoustic energy conversion for ultrasonic wave generation and data collection. The signal processing unit 108 can include a processor 110 and a memory 114 for executing signal processing algorithms in the memory 114. Processed signal data can be output to a computer via an output unit 114. The waveguide 100 can include one or more sensors 112, where each sensor 112 can be constructed with one or more surface discontinuities such as but not limited to gratings with sensor features such as but not limited to cuts, notches, kinks expansions, contractions, engravings, surface treatments, surface coatings, etchings, weld spots, changing geometry, etc. Embodiments for the orientation, placement, and functionality of the sensors 112 are discussed more fully below.

In the embodiments, the transducer 104 can be actively driven by the interrogation unit 106 for acoustic wave generation with an electrical signal selected from a form of large bandwidth narrow pulse or tone bursts of frequencies with a singular or plural cycle counts. The signal processing unit 108 can output 116 the interpreted environmental information in a way selected from a form of a graphical user interface, displays, cabled data transfer connections, wireless data transfer connections, or other known output methods and devices.

In order to perform the functionalities discussed herein, the signal processing unit 108 may include the processor 110 and the memory 114. The memory 114 may store instructions that, when executed by the processor 110, causes the processor 110 to analyze for an environmental attribute, such as temperature. The memory 114 may be a non-volatile memory or a volatile memory. Examples of non-volatile memory may include, but are not limited to, a flash memory, a Read Only Memory (ROM), a Programmable ROM (PROM), Erasable PROM (EPROM), Electrically EPROM (EEPROM) memory, and a hard drive. Examples of volatile memory may include, but are not limited to Dynamic Random Access Memory (DRAM), and Static Random-Access memory (SRAM). The memory 104 may also store various data (e.g., acoustic wave propagation parameter data, environmental attributes data, generated acoustic wave pulse data, reflected acoustic wave pulse data, etc.) that may be captured, processed, and/or required by the acoustic sensor 100. By way of an example, by using output device 108, the processor 110 may be used to render a sensed parameter to a user via a display screen (not shown). Collected signals can also be output 116 to a computer with a processor and post-processing software for further analysis (not shown).

The waveguide 100 and ultrasonic adapter 102 may be configured to be installed inside of an enclosure. The ultrasonic transducer 104 may be configured to be installed outside of the enclosure. The waveguide 100, ultrasonic adapter 102, and ultrasonic transducer 104 can be configured to be operable in a temperature range of about −50° C. to 2800° C.

In some embodiments, the transducer 104 may be configured to generate an acoustic wave pulse and receive a reflected acoustic wave pulse. The transducer 104 can be designed using metal-ceramic, high-temperature and radiation-tolerant piezoelectric materials, allowing a long operation life in harsh conditions. The exemplary ultrasonic adapter 102 can be designed to allow ultrasonic waves generated by the transducer 104 to propagate to the ultrasonic waveguide 100 and vice-versa. The efficiency of the adapter 102 will directly affect the signal-to-noise ratio of the signals, which will further affect the precision and resolution of temperature measurements.

In some embodiments, when ultrasonic waves transmitted from the transducer 104 propagate along the waveguide 100, a sensor 112 can reflect part or all of the ultrasonic energy from the ultrasonic waves back to the ultrasonic transducer 104, and the reflection signal reaches the maximum when the sensor 112 spacing equals integer times of the half wavelength of the incident ultrasonic wave. In the remaining disclosure, the sensor 112 may be referred to as a “grating” in a preferred embodiment, however this is not limiting and in alternative embodiments the sensor 112 and sensor features may be other structures as disclosed herein. The reflection signals detected by the ultrasonic transducer 104 and the interrogation unit 106 are a function of the physical parameters (such as temperature and the presence of fluid) at the grating location. From detected reflection signals by the ultrasonic transducer 104, those physical parameters at each grating 112 in the waveguide 100 can be accurately determined. The ultrasonic adaptor 102 may be used to improve the energy transfer between the ultrasonic transducer 104 and the waveguide 100 of a different size such that the waveguide length can be longer. The interrogation unit 106 can excite the transducer 104 with either broadband short-pulses or narrowband tone-bursts with a center frequency/wavelength tuned to match a particular grating under interrogation in the waveguide.

In the embodiments, the ultrasonic transducer 104 may be selected from one of a piezo-electric, electromagnetic, magneto-restrictive or electro-mechanical transducer. Wavemodes may be selected from the group of longitudinal, torsional, flexural, anti-symmetric, symmetric, and shear horizontal. In the embodiments, the ultrasonic adapter 102 may be composed of a metallic material and alloys such as, but not limited to, stainless steel, nickel, Inconel, tungsten, or molybdenum. In other embodiments, the ultrasonic adapter 102 may be selected from a form of clamp, backing, exponential ultrasonic horn, conical ultrasonic horn, catenoid ultrasonic horn, ultrasonic horn, rectangular ultrasonic horn, singular or multiple step ultrasonic horn, or wedge type ultrasonic adapter. The method of attachment or connection of the ultrasonic adapter 102 to the waveguide 100 may be selected from a form of adhesive, welding, soldering, friction welding, screwing and clamping.

In some embodiments, when ultrasonic waves transmitted from the transducer 104 propagate along the waveguide 100, a sensor feature from one or more sensors 112 can reflect all or part of the ultrasonic energy back to the transducer 104, and the reflection signal reaches the maximum when the sensor spacing equals integer times of the half wavelength of the incident ultrasonic wave. The reflection signals detected by the transducer 104 and interrogation unit 106 are a function of the physical parameters (such as temperature and the presence of fluid) at the grating location. From detected reflection signals, those physical parameters at each grating 112 in the waveguide 100 can be accurately determined. In one embodiment, an adaptor 102 may be used to improve the energy transfer between the transducer 104 and the waveguide 100 of a different size such that the waveguide length can be longer. The interrogation unit 106 can excite the transducer 104 with either broadband short-pulses or narrowband tone-bursts with a center frequency/wavelength tuned to match a particular sensor 112 under interrogation in the waveguide 100. By analyzing the corresponding frequency components in reflection signals detected from the broadband excitation by signal processing unit 108 or tuning the center frequency one-by-one for each grating in the waveguide 100 from tone-burst excitation, physical parameters such as temperatures at each grating position of the waveguide 100 can be determined, and/or the fluid level of the medium that the waveguide 100 is dipped into can be measured.

In the embodiments, the waveguide 100 may be configured in a solid rod, wire, plate, ribbon, sheet, hollow tube, pipe, or shell form and may be composed of a metallic material and alloys such as, but not limited to, stainless steel, nickel, Inconel, tungsten, molybdenum, or any material that will operate according to the parameters disclosed herein. Preferably, a waveguide's length can range from 5 cm to 20 meters, but it is not limited to this range and may vary in other embodiments. Each exemplary sensor 112 feature on the waveform 100 can have a form of periodically structured gratings comprised of discontinuities, such as selected from notches, kinks, expansions, contractions, cuts, engravings, surface treatments, surface coatings, etchings, weld spots or changing geometry. In the embodiments, each grating 112 can have an internal geometry designed in accordance with a plurality of fractions of the target wave mode's frequency and corresponding wavelength. In an embodiment, the spacing arrangement of gratings 112 on the waveguide 100 is not uniform.

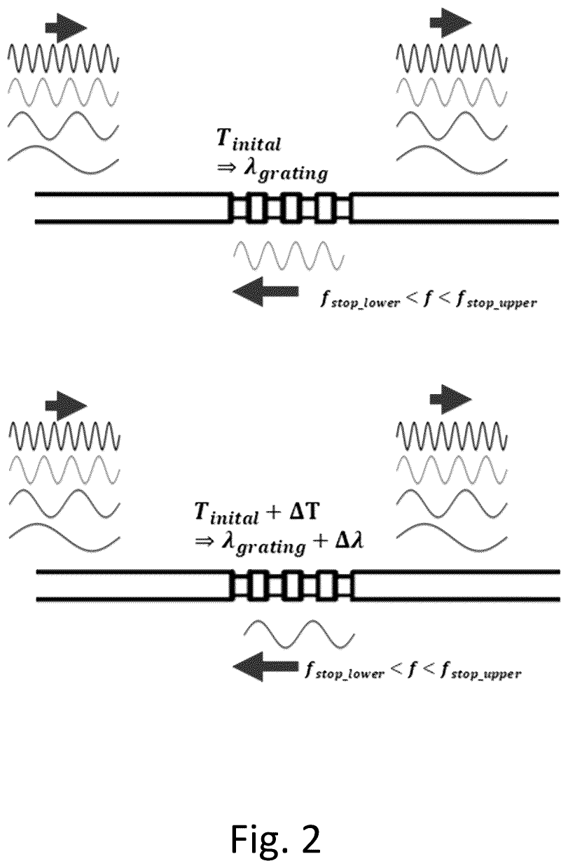

FIG. 2 is a schematic illustration of frequency-selective reflection from a grating structure on a waveguide according to the embodiments. In the embodiments, the UMTS can utilize frequency reflection using periodic grating geometries. In photonics, periodic geometries are common for light and other electromagnetic waves. For example, Fiber-Bragg grating and Bragg mirrors are among the most notable examples of such practice. Quite recently, some ultrasonic applications of Bragg mirrors-like reflectors have been investigated by other researchers. Incoming waves within certain frequency bands will get reflected by the gratings; meanwhile, other waves will be able to transmit through with relatively low reflections. Different points that contain gratings will be probed with excited waves. The reflective behavior of the gratings will be altered with changing temperatures. Therefore, the spectral structure of the reflected wave from the grating will be different. FIG. 2 illustrates these concepts.

In some embodiments, the UMTS utilizes frequency selective reflectors (i.e., sensors) to eventually arrive at a temperature measurement. During the development of the UMTS, one attempt was made to leverage created bandgaps in the vibration spectrum if the waveguide by machining gratings to develop an efficient reflector and waveguide design. This approach was ultimately deemed unfeasible, but analyzing this approach can help explain the underlying physics of this difficult problem, which had an impact on the design process of the exemplary embodiments that were ultimately successful. The embodiments' designs use a more empirical approach stemming from the relationship between reflection and wavelength, which yielded successful results providing the final designs of the UMTS system and method.

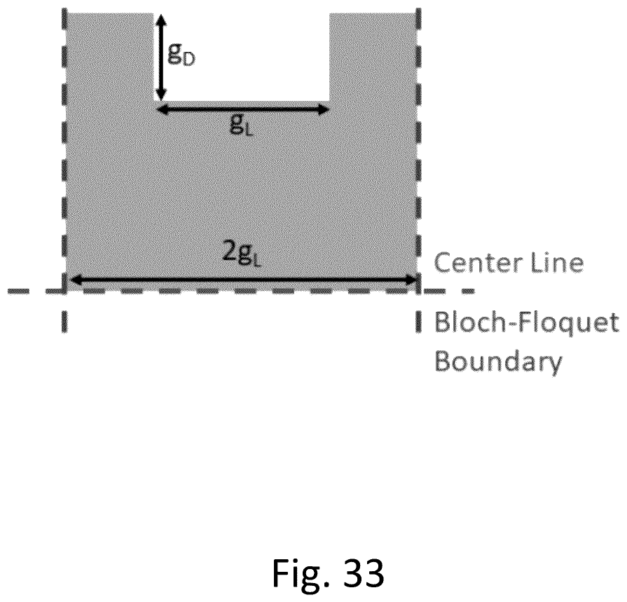

The first bandstop approach was ultimately deemed unfeasible. It is important to understand the frequency selectivity of gratings of different dimensions and geometries. Ideally, periodic gratings on the waveguide structure alter the waveguide's dispersion behavior and create bandgaps where the material does not contain harmonic modes. Therefore, reflectors targeting specific frequencies by tuning the size and periodicity of such gratings can be manufactured. Optimal parameters and geometries for the grating design are studied through the analysis of dispersion curves and band diagrams. To generate dispersion curves and block diagrams, a unit cell of a grated section is simulated with periodic Bloch-Floquet boundary conditions using COMSOL Multiphysics. A basic design of such a rectangular grating pattern as a unit cell can be found in FIG. 33 as a 2D axisymmetric model, marking the parameters grating length (g_{L}) and grating depth (g_{D}), and radius of the bar. Base waveguide geometry is taken to be a ⅛″ diameter steel rod with an elastic modulus of 197.5 GPa, Poisson's ratio of 0.27, and density of 7970 kg/m³.

The first bandgap of each grating configuration is marked with a red rectangle. Band diagrams are commonly utilized in solid-state physics and crystallography. Since the embodiments create frequency gaps without harmonic modes, in this context, using band diagrams is helpful to visualize such frequency ranges easily. A waveguide with no gratings does not have such band gaps. However, periodic gratings introduce bandgaps that selectively reflect waves of particular frequencies. Although individual band gaps are quite visible from the block diagrams, comparing bandgaps of different geometries is difficult. To be able to visualize the bandgap of each configuration better and compare various bandgaps with each other, “squeezed” band diagrams along the wave number as if every point in frequency shares the same wavenumber and plotted different grating geometries together can be plotted. More prominent bandgaps can be observed in the deeper grating geometry, a depth of 1 mm. However, such gratings on a thin rod result in fragile structures that fracture fairly easily. Therefore, geometries with such thin features for a final product were not considered as feasible.

Although rectangular notches and gratings are commonly utilized in the literature, manufacturing such straight edges can be challenging in small lengths and may require more specialized tools. However, many common machining profilers can manufacture gratings with sloped edges. Because of the common cutting tool geometries, it is more feasible to manufacture gratings as triangular notches or rectangles with sloped edges. However, this change in geometry affects the dispersion behavior and band structure and needs to be evaluated separately. Periodic consecutive notches machined to the surface is the first alternative geometry to consider. This design has significant advantages in the manufacturing process. Therefore, a similar dispersion bandgap analysis on such geometry was performed. This geometry yielded smaller bandgaps with higher frequencies. Therefore, it requires higher operating frequencies. Another possible grating shape is a rectangle with sloped edges, a trapezoid shape. This geometry is close to the ideal rectangular gratings; however, it has sloped edges corresponding to the cutting tool and is, therefore, more convenient to manufacture than rectangular grating. The resulting bandgaps with different gratings lengths yield similar results to rectangular gratings with straight edges.

To evaluate the effectiveness of the proposed triangular grating geometry, we performed finite element analysis (FEA). A 1 ft. stainless steel waveguide with three triangular notches with a 7 mm distance from each other and a ⅛ in. diameter stainless steel rod was modeled in a software environment. An increased number of notches in the grating will increase the effects of the grating and the behavior will approach the dispersion analysis. However, increasing the number of gratings also increases the total length of the grating covers. The increasing grating length would decrease the spatial accuracy of the measurements; therefore, a compromise is required. Since three notches span about two centimeters with the given notch spacing this geometry was used. An acoustic wave on the waveguide is generated by applying a compressional input from one end of the rod in a single cycle 170 kHz sinusoidal tone burst in ABAQUS/Explicit environment. During 300 μs of analysis, reflections, echoes, on the excitation point from the grating are significantly smaller than reflections from the end, and the wave propagates almost unperturbed. The propagation of the effects of the grating was minimal. Therefore, although the initial dispersion analysis looked promising, this design is not feasible for the current application. Parametric studies are performed based on the different signal frequencies. As input signal frequency increases, the reflected signal also increases its amplitude. However, higher frequencies have relatively noisy signals from boundary reflections, making them difficult to interpret the desired signal in the time domain.

A similar FEA was performed for three 10 mm trapezoid gratings geometry to evaluate the feasibility of the proposed trapezoid grating geometry. A 1 ft stainless steel waveguide with three trapezoid notches with a 100 mm length, ½ mm depth, and ⅛ in diameter stainless steel rod was modeled in a software environment. An acoustic wave on the waveguide was generated by applying a compressional input from one end of the rod in a single cycle 74, 96, 100, and 192 kHz sinusoidal tone burst in ABAQUS/Explicit environment. During 300 μs of analysis, reflections and echoes, and comparing the end and grating reflections, the grating's transmittance and reflectance for different frequencies can be determined. In this test, both reflections decrease with increased frequency. There are multiple approaches to analyzing this behavior. First, this indicates a decreasing power transfer to the waveguide with increasing frequency. During the simulations, the amplitude of the tone burst was kept constant while increasing the frequency. Therefore, absolute-total power supplied to the system was decreased, and a decrease in energy in the system was expected. However, by looking at the ratios of the echoes, the transmittance and reflectance of the grating in the given frequency level can be compared. With the increasing frequency, reflectance from the reflectors monotonically increased, which act as an acoustic low-pass filter. Although this behavior clashes with the dispersion analysis and expected bandstop behavior, it is not non-intuitive. However, the conflicted results from the dispersion and FEA analysis make it difficult to draw conclusions. Therefore, experimental validation is required to determine the grating behavior.

A second, wavelength approach, was ultimately deemed successful for the applications of the embodiments of the present invention. Discontinuities present in a waveguide can cause certain portions of ultrasonic energy to scatter and reflect back to the source. If these discontinuities are introduced periodically, they can result in an additive effect on the reflective signal. Depending on the periodicity of these discontinuities and the wavelength of the interacting wave, reflected waves from different discontinuities can amplify each other, resulting in certain frequencies being reflected with a consistent reflection signal. To create selective reflectors based on the wavelength of the incoming wave, the embodiments introduce gratings to the cylindrical waveguide with a periodicity of half the wavelength of the targeted frequency. This approach aims to enhance the reflection of specific frequencies by manipulating the interaction between the ultrasonic wave and the waveguide's structure.

As mentioned previously, waveguide rods are commonly employed in ultrasonic sensing applications, particularly in time-of-flight measurements using compressional modes that resemble Lamb waves. As longitudinal modes follow the Pochhammer-Chree dispersion relation, they are generally non-dispersive, making them ideal for such measurements. The use of stainless steel (316) is preferred due to its resilience to high temperatures and corrosion, making it suitable for use in harsh environments. To measure temperatures in such challenging conditions, longer waveguides are preferred as they offer three key benefits: an increased range for temperature sensing, the ability to place the transducer in less harsh conditions, and the ability to incorporate more reflector sets onto the gratings on the waveguides. To transmit acoustic energy over longer distances, non-dispersive guided waves and relatively lower operational frequencies are required. The use of thinner rods as waveguides facilitate the generation of guided waves with greater ease. Due to the considerations mentioned above and the fact that thinner rods can reach and fit into different and difficult structures, utilizing even thinner waveguides than the previous test was appropriate. In an embodiment, a diameter of the waveguide was 1/16 in for a stainless steel cylindrical rod. Considering only longitudinal modes, the fundamental mode is the only mode present in the structure for a little bit more than the first 2 MHz. Furthermore, the fundamental mode is non-dispersive for the first few hundred kHz. This thinner waveguide provides a larger frequency range with a cleaner signal.

The reflectors and gratings will be composed of several periodic discontinuities established on the waveguide. Every reflection originating from these individual discontinuities will add up with other reflections from various discontinuities, leading to the generation of a combined reflected signal. If an individual reflection distorts the signal significantly, the cumulative effect will not represent the frequency-selective nature of the grating. In order words, making large notches to create gratings will not be effective when a signal notch scatters most of the acoustic energy spanning a large range of wavelengths. Therefore, it is essential for notches forming gratings to be very small compared to the wavelength and relatively unobtrusive. Making small discontinuities on a thin waveguide with a reliably controllable geometry is not trivial; hence, design and analysis will be based on practical notch shapes to establish the grating structure. Making notches of these scales is not feasible with machining and grinding methods. To create tiny notches on the stainless-steel waveguide, a side cutter was utilized and incorporated the resulting geometry from the engraving into numerical simulations and analysis. A notch-style grating was designed under a wavelength-based design approach. Also, the notch-style grating does not encircle the rod axis.

FEA was performed on the 3 mm depth, 10 mm spacing, and 3 notches. Two points near the input source location are fixed, and a pressure condition is assigned to make the signal. A 3 MHz high-frequency signal was applied to measure the response from gratings. Displacement (m) and directional stress (Pa) into the longitude direction were measured from FEA. Noisy signals were observed on both displacement and stress measurements. It is difficult to observe the difference in the stress observation, but the displacement data could catch reflections from gratings to some extent. To identify the effect of grating numbers, FFT analysis was performed. Analysis reveals that the increment for the number of gratings also increases the amplitude from the reflection, but signals become similar after 3 gratings—only a small difference is observed. Due to the low reflectivity of the notch structure and the difficulties in manufacturing, consideration of other waveguide designs was warranted.

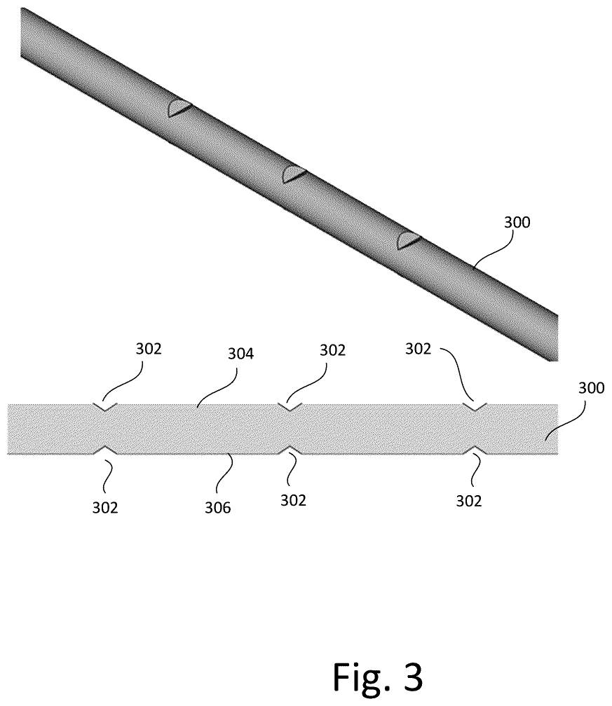

FIG. 3 is a 3D model and cross-section of an embodiment of a waveguide 300 with a 3-cut grating. Waveguide 300 and waveguide 100 can be substituted for one another in the embodiments. In this design, the notches 302 are present symmetrically on the top 304 and the bottom 306 of the waveguide 300. In addition to ease of manufacturing, a better reflection from the gratings is expected with this geometry. Unlike the previous study, 2D analysis is investigated to reduce the computational cost in this task. Boundary conditions are updated compared to previous sections. The displacement is assigned on the left side of the waveguide rod. Roller conditions that restrict the vertical motion are assigned on top and bottom. Fixed condition is applied on the end of the waveguide. By imposing boundary conditions, it becomes possible to limit the impact of noisy signals originating from unbounded regions above and below while also constraining motion in the horizontal direction to achieve a clear reflection signal form the discontinuities. In FIG. 3, in an embodiment the notch 302 depth is 0.1 mm, and the width is 0.4 mm, however these dimensions are exemplary and can vary greater or lesser depending on the waveguide 300 dimensions, application, etc. Also, notches 302 are located on top 304 and bottom 306 of the waveguide rod 300 while maintaining the same vertical location.

As the first step of experimentation, the number of notches 302 on the waveguide 300 was investigated. For this test, a 1 MHz tone burst signal—3.5 cycles was applied (maximum amplitude: 1e-9), and 2.5 mm spacing between notches, which is half the length of the wavelength, was used. If the time signal is observed, the number of notches affect the signal's amplitude and width; with the increasing number of notches, the amplitude and the width of the signal increase. However, the amplitude of the signal seems to taper and stay the same after three notches. In analysis, although the peak from the last notch is visible, other parts of the reflection from different numbers of notches match almost exactly. The ratio between input and maximum reflected amplitude is calculated to be around 0.048 after three notches. However, the effect of the increasing notches is more visible in the frequency. As more notches are added to the grating, the amplitude of the reflection at the target frequency increases. Similarly, the reflected signal becomes narrower as the number of notches increases. This leads to a decrease in the bandwidth of the reflection, which is a result of the stronger frequency selectivity of the grating. FFT analysis was performed to identify reflected signals in the frequency domain. Only reflected signals from notches are analyzed in the frequency domain. The effect of the gratings on the reflectivity is highly notch distance/wavelength dependent. Therefore, improper spacing creates an improper grating. An FEA analysis was performed when the improper spacing between notches was assigned on the waveguide. The signal response when improper spacing is assigned—3 notches are considered for the analysis. 25 mm spacing, which is 10 times longer, is assigned for the 1 MHz signal. The signal showed the reflection from each notch, was completely separated and provided no unified grating response.

Once the impact of the number of notches on the reflectivity of the grating had been examined, the next step was to investigate how temperature affects the reflectivity. Previously presented geometry with 9 notches and boundary conditions are used in this study. In addition, the material properties are updated to consider a thermal effect. The temperature-dependent elastic modulus, which shows a linear relationship during the temperature changes, is applied. Abaqus fully coupled thermal-stress analysis is investigated with an explicit solver. It was assumed that thermal is applied on notches only and is not propagated to other parts. Room temperature (20° C.) is assigned except for the grating location. The notch temperature is increased from 20° C. to 400° C. with 9 intervals analyzed.

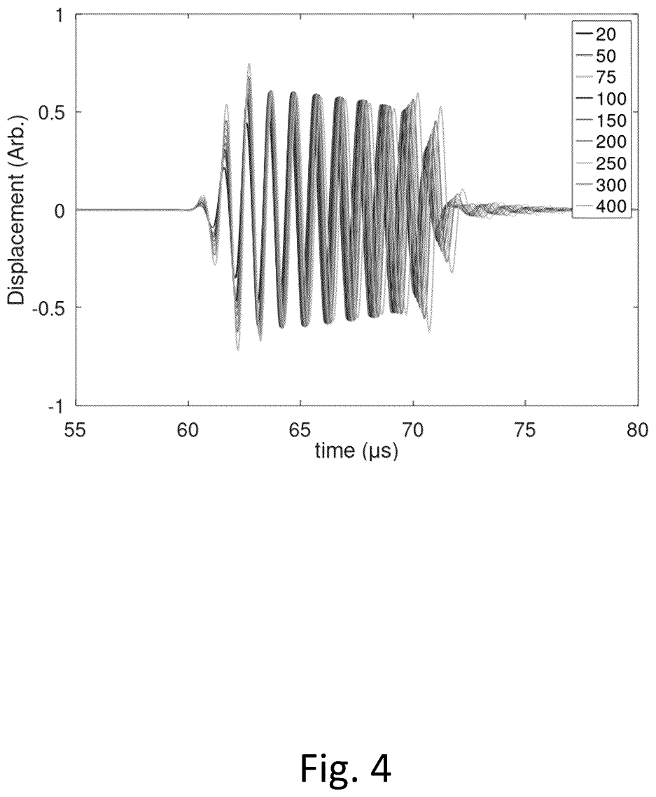

FIG. 4 shows a finite elements analysis simulated reflection signals from a grating at elevated temperatures according to the embodiments. In FIG. 4, the reflected signal response from the grating in different temperatures is graphed, illustrating a few changes on the signal with temperature. First, with increasing temperature, some increase in temperature was observed. Second, with the increasing temperature, the signal reflected signal becomes wider. This shows a correlation between the temperature and the reflected signal. As the temperature increases, lower frequencies of the signal are mainly reflected.

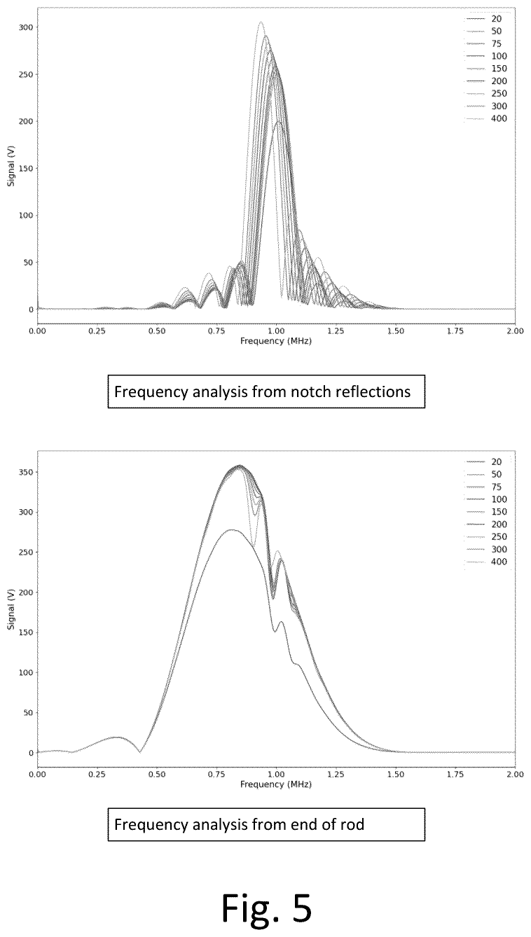

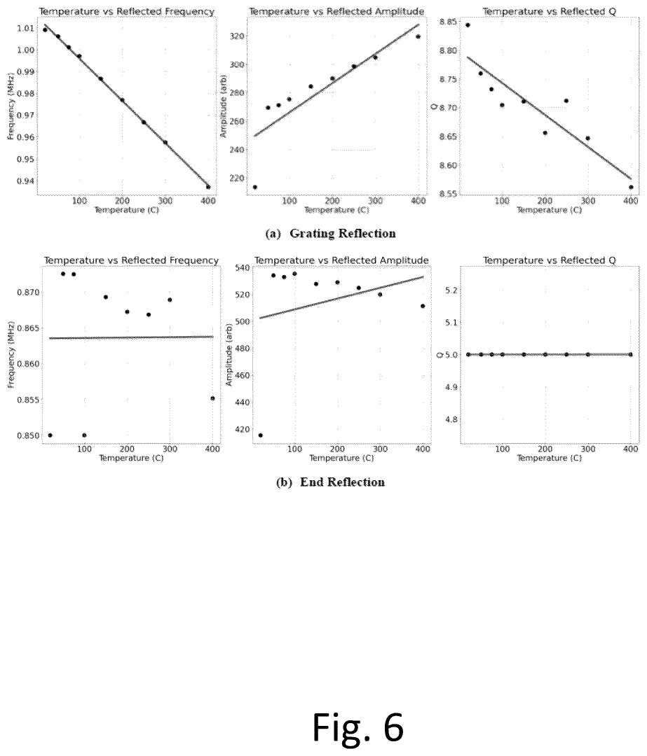

FIG. 5 is a plot of frequency analysis of finite element analysis (FEA) simulated grating reflection signals at elevated temperatures according to the embodiments. FIG. 6 includes plots of correlations between the temperatures and extracted features from the FEA simulated grating reflecting signals according to the embodiments. FIG. 5 and FIG. 6 show an FFT analysis to the reflection from the grating and the end of the waveguide. Three quantities of the reflected signal are especially focused on, frequency of the wavepacket, amplitude, and bandwidth (quality factor, Q) of the wavepacket. The plot shows that with increasing temperature, the frequency of the reflection decreases. While other temperature effects are also present, such as increasing amplitude and decreasing Q, change in frequency is seen to be the most reliable one with an almost perfect linear trend. Meanwhile, it is not possible to see a strong correlation between the quantities and temperature in the end reflection signal. FIG. 6 shows fitting results from reflected signals. Although a strong correlation was observed in the grating reflection, there appears to be no correlation between the reflected signal from the end and the temperature.

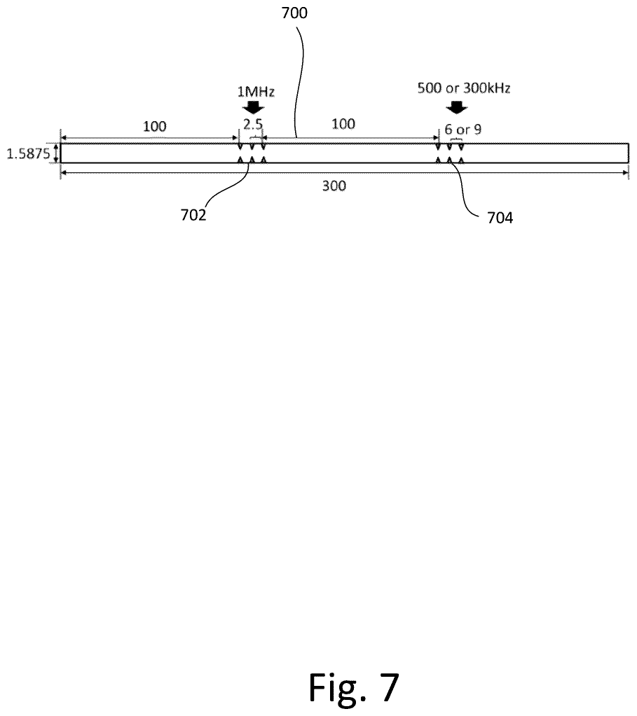

The embodiments can measure the temperature of different locations along the exemplary waveguides. In an embodiment, to probe multiple points on an exemplary waveguide 700, multiple gratings are required. In the embodiments described above, 1 MHz signals with grating of 2.5 mm notch distances were tested. In these embodiments, 300 kHz (9 mm spacing) and 500 kHz (6 mm spacing) acoustic waves are used. The overall structure of the FEA was kept the same as the previous test, and the illustration of the geometry can be found in FIG. 7. The excitation is provided from left to right and the first grating 702 was targeting 1 MHz while two different waveguides 700 were simulated where the second grating 704 either targeted 300 kHz or 500 kHz waves.

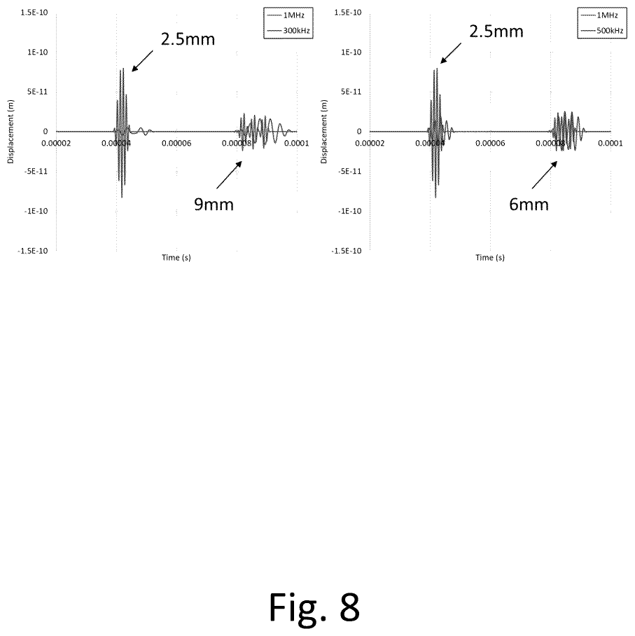

FIG. 8 illustrates plots of results for different spacing and input signals with 1 MHz assigned for both cases of the waveguide of FIG. 7. Reflections from corresponding notches have higher amplitudes than non-corresponding ones. A distinguishable reflected signal is observed in the 9 mm spacing case with a 3.4 times higher amplitude than in the 2.5 mm spacing case under a 300 kHz input signal. Utilizing 1 MHz and 500 kHz gratings does not seem to be as effective as the 1 MHz-300 KHz combination, as the 500 kHz signal reflects from the 1 MHz grating significantly. This could be due to similarities between the half and full wavelengths of the signals. Temperature-dependent studies are performed to identify the thermal effect on the signal reflection. Two different input signals—1 MHz and 300 kHz and Four temperature conditions—20-20, 20-200, 200-20, 200-200 (Temperatures (° C.) on 2.5 mm spacing-9 mm spacing, respectively) are studied. As in the previous study, gratings are heated to measure signal responses.

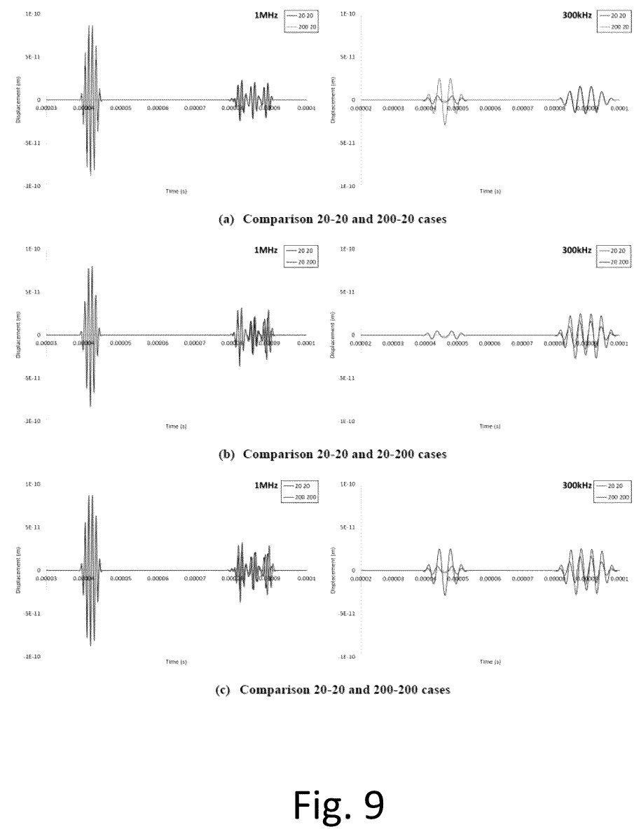

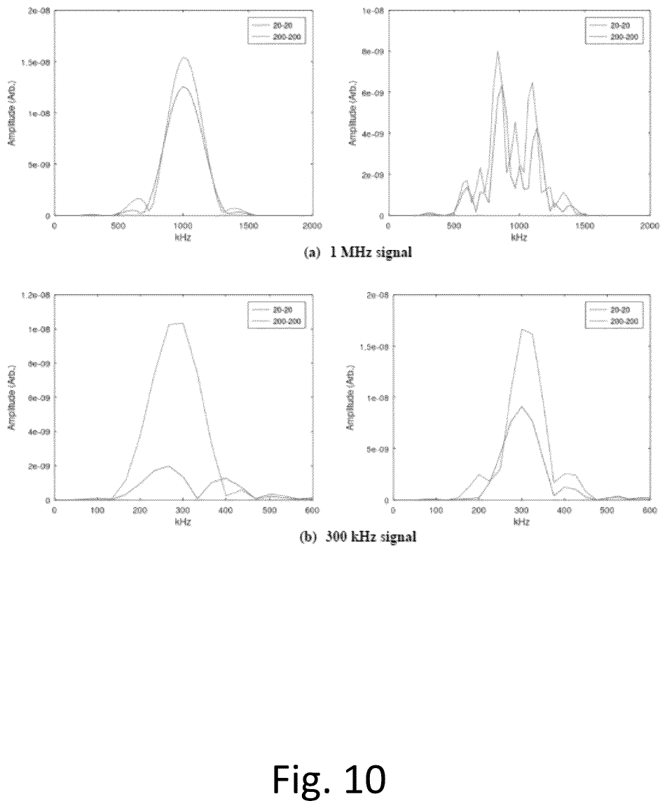

FIG. 9 displays FEA results for various signals and temperatures of the waveguide of FIG. 7. Small time shifting is observed on second notches when the first grating is affected by heat. Unaffected gratings show perfectly overlapped signals. The amplitude of reflected signals increases with temperature on affected notches, and frequency. FIG. 10 illustrates FFT analysis for notch sets under different input signals from FIG. 9 of the waveguide of FIG. 7. The charts in FIG. 10 confirm the trends observed in FIG. 9 with increased maximum amplitude, frequency shift and range restrictions as the temperature rises for the 1 MHz signal and the 300 kHz signal.

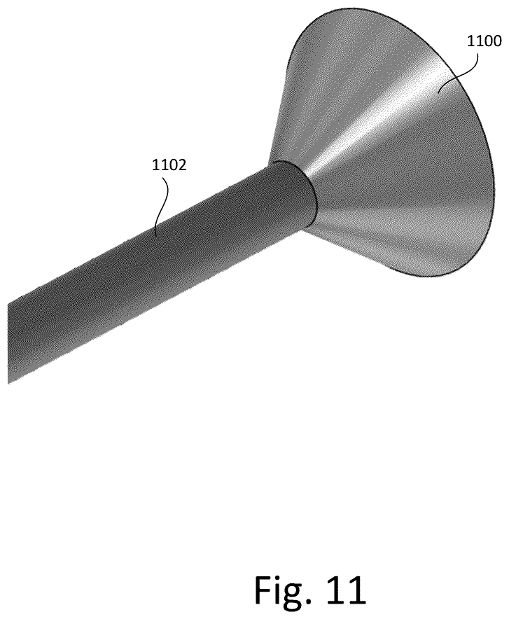

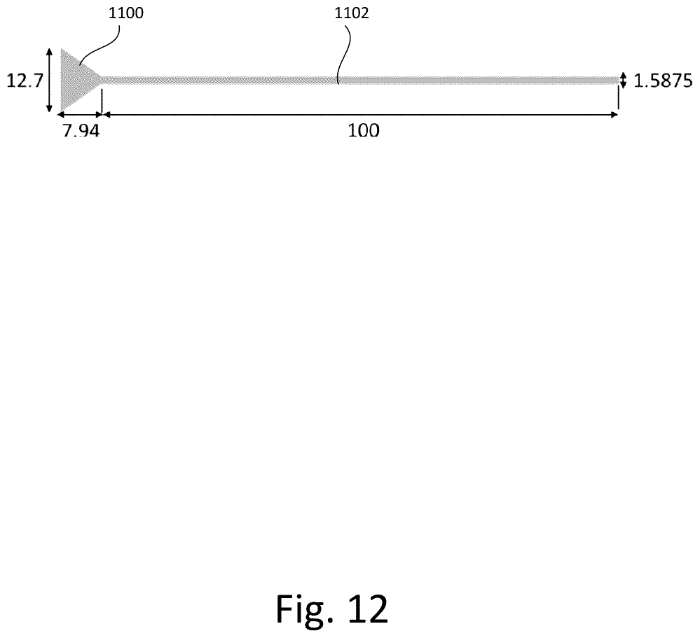

The primary function of the ultrasonic adapter 102 is to connect the designed waveguide 100 to the ultrasonic transducer 104, which enables the transmission of acoustic signals from the transducer 104 to the waveguide 100. It is important in an embodiment that the adapter 102 does not introduce any, or any detectable or interfering, parasitic excitation or additional noise, nor should it suppress desired wave modes. Therefore, an ideal adapter 102 would provide an efficient transfer of ultrasonic energy between the transducer 104 and the waveguide 100. Three types of adapters were tested with the UMTS assemblies of the embodiments: Besier horn adapter, conical horn adapter, and short conical horn adapter. FIG. 11 is a 3D model of an exemplary short conical horn adapter 1100 connected to an exemplary waveguide 1102 that provided the best results of the three types of adapters tested. A two-dimensional analysis was performed to find a signal behavior. Same as in the previous study, a 1 MHz tone burst signal was applied as the input source on the left side of the horn (6 mm diameter). An embodiment for a 100 mm waveguide without notch or grating was applied to measure the reflection from the end. FIG. 12 illustrates a side view of the exemplary conical horn adapter 1100 and elongated waveguide 1102 used for testing with exemplary dimensions in millimeters.

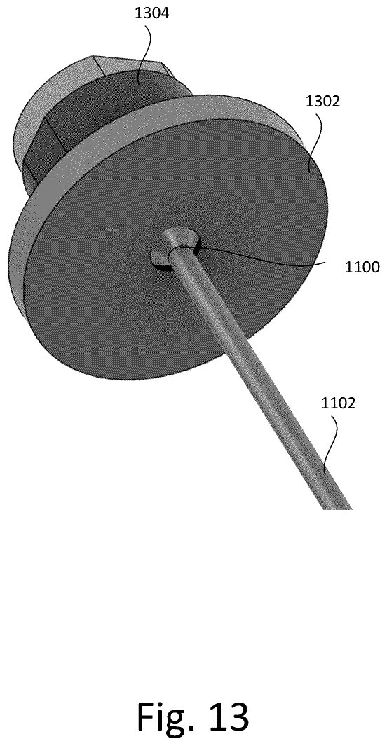

FIG. 13 is a 3D model of an exemplary embodiment of assembly 1300 focusing on a waveguide adapter connection. This embodiment includes the waveguide 1102, and the conical horn adapter 1100 connected to and partially housed within an exemplary threaded front cap 1302. The front cap 1302 is then connected to an exemplary ultrasonic transducer 1304. Any connection that would function to accomplish the operational aspects of the assembly is possible such as but not limited to, threaded, welded, etc. In another embodiment, for improved acoustic coupling between the crystal and the waveguide, colloidal silver paint was employed as an acoustic coupling agent. This paint has high conductivity and effectively establishes a ground contact for the piezoelectric crystal and enhances the acoustic coupling between the crystal and the waveguide.

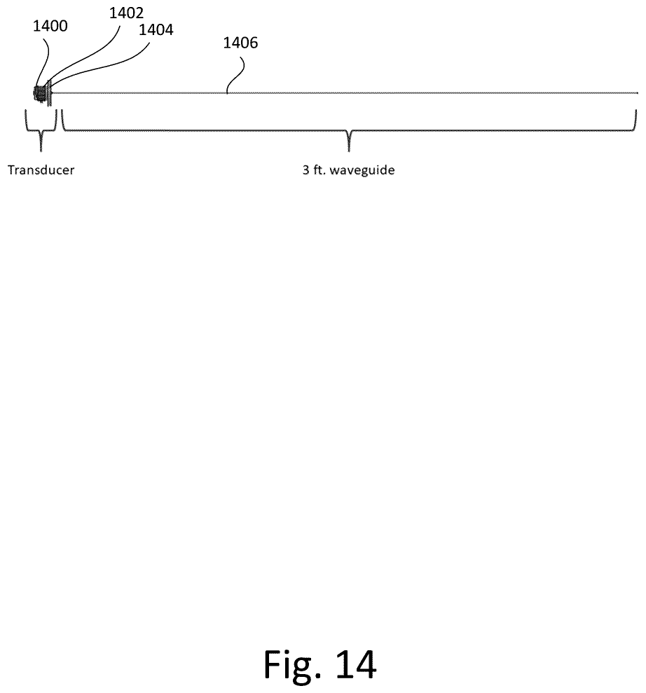

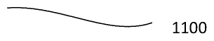

FIG. 14 is a 3D model of an exemplary waveguide assembly of a sensor, ultrasonic adapter, and ultrasonic transducer according to the embodiments. The exemplary assembly includes ultrasonic transducer 1400, ultrasonic adapter 1402, front cap 1404, and waveguide 1406. The transducer 1400, the ultrasonic adapter 1402, and the waveguide 1404 are similar in aspects to the corresponding elements in other embodiments herein. Waveguide 1404 measures approximately three feet in length. The length of the waveguide 1404, and any waveguide presented in this disclosure, is exemplary and may vary more or less depending upon many factors including but not limited to installation logistics, applications, designs, conditions, orientations, etc.

The exemplary assembly in FIG. 14 was tested using single-point and multi-point experiments using the wavelength approach to collect temperature measurement. Although single-point temperature measurements are commonly performed with waveguide-based ultrasonic sensors, analyzing single-point temperature measurements using the exemplary wavelength approach with the exemplary UMTS assembly has two main benefits. First, multiple-point measurements build upon single-point measurements. Therefore, achieving single-point measurements is a prerequisite for multiple-point measurements. Second, and more importantly, the state-of-the-art single-point ultrasonic temperature measurement depends on the time of flight measurements on a section of the waveguide. Therefore, the actual measured temperature is not on a point but the average temperature over a section. However, the novel exemplary methods of the embodiments conduct temperature measurements on a small grating rather than a section of the waveguide, in contrast to prior methods. Additionally, single point assemblies do not have to analyze the results for acoustic wave interference, inconsistencies, etc. of other measurement sensors on a waveguide and therefore cannot be extrapolated to multiple point measurements.

To conduct temperature testing for temperature measurements, a test setup similar to the preliminary tests herein was followed but with the addition of a heat source. For this purpose, a hot plate was utilized. To ensure stability during the experiment, gratings were centered on the hot plate and taped the waveguide onto it using high-temperature masking tape. To monitor the temperature during the experiment, a K-type thermocouple was placed between the grating and the hot plate and the temperature readings were manually logged at different temperatures after the reader reached the thermal equilibrium. While waiting for thermal equilibrium to be reached before collecting data, it was found that the manual collection of data introduced an uncertainty of less than 1° C. to the experiments. Despite the relatively high temperatures utilized during the testing process, the non-grated portions of the rod remained at virtually ambient temperatures and were safe to handle. This behavior can be attributed to the thin geometry of the waveguide used in the experiment, which acted as a thermal insulator, preventing the heat from reaching the non-grated portions of the rod. Therefore, utilizing a thin waveguide and establishing a distance between the high-temperature source and the transducer could potentially protect the transducer from high temperatures and increase the temperature resistance of the sensor beyond the Curie temperature measurements.

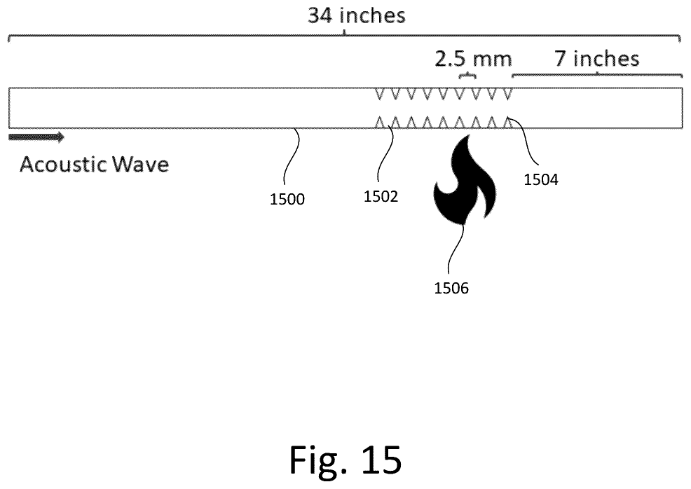

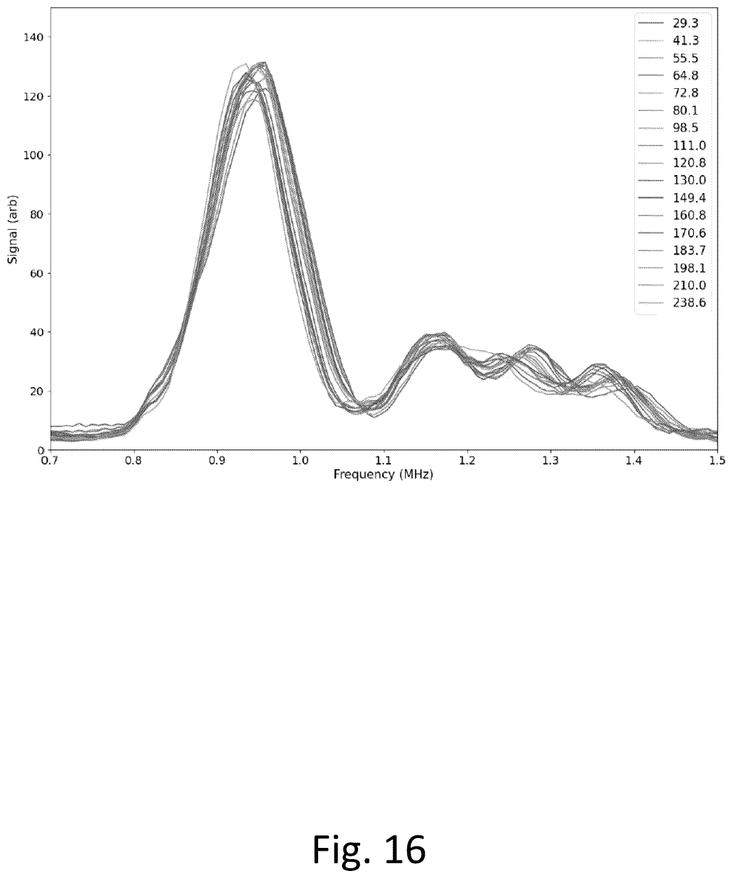

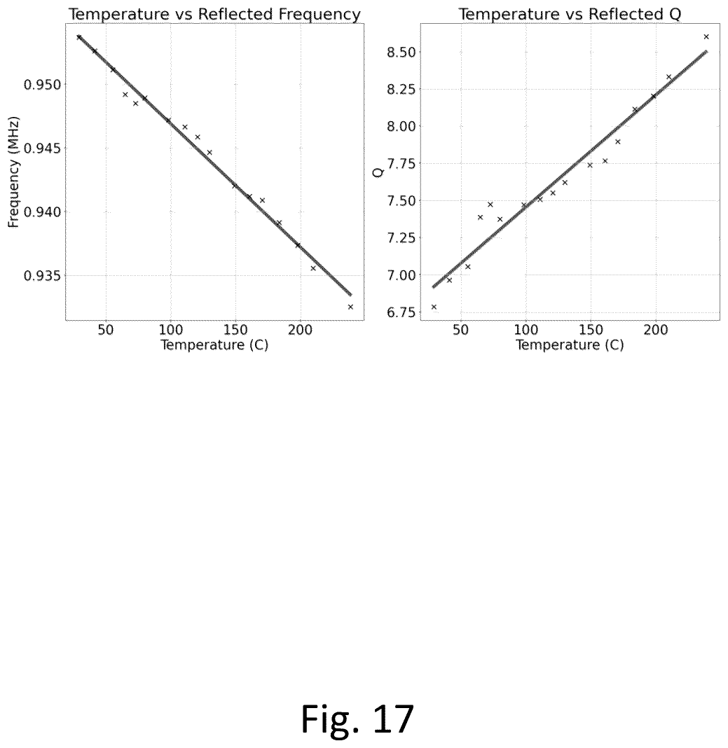

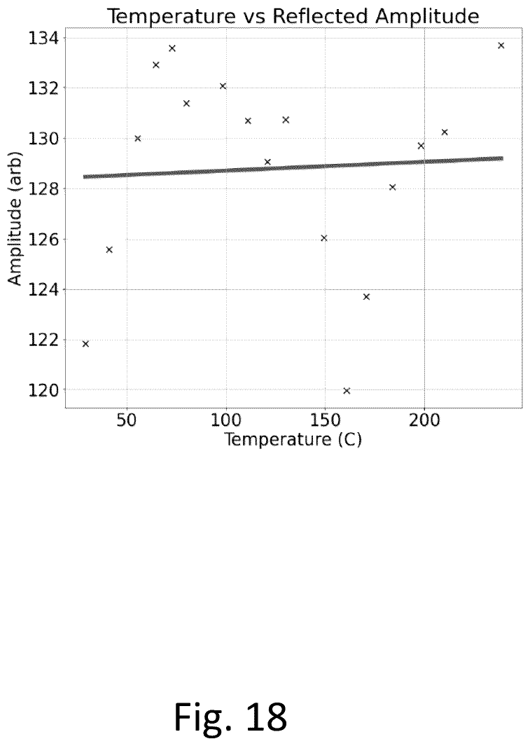

As the preliminary experimentation showed, utilizing 2.5 mm grating was feasible, and therefore the first temperature experiment using 2.5 mm grating with 9 notches focusing around 1 MHz was performed. The grating is engraved 7″ from the end of the 34″ waveguide rod. As in the previous experimentation, the ultrasonic signal was created using a broadband pulser receiver, and the frequency of interest was isolated using signal processing techniques. The temperature was increased from ambient to 238.6° C. incrementally. FIG. 15 illustrates an exemplary waveguide 1500 for single point temperature experiment with UMTS embodiments using a single grating 1502 with multiple notches 1504 and with a heat source 1506. As per preliminary experimentation, the grating 1502 reflection was expected to be collected around 0.28 ms after the trigger, and the end reflection was expected to be collected around 0.33 ms at 1 MHz. Hence, to analyze, the echo signal between 0.2 ms and 0.33 ms was cut. To see the grating's temperature-dependent reflectance behavior, the FFT of the cut signal was calculated for each temperature value. FIG. 16 is a plot of the FFT of the grating of the reflection signal from the test. By fitting to an appropriate Lorentzian function, the reflected signal's center frequency was extracted, along with amplitude and Q-factor. From this experiment, it was observed that a strong linear correlation between the temperature and center frequency of the reflected signal and Q-factor as see in FIG. 17. FIG. 17 shows plots of temperature vs. reflected frequency center and Q factor for the single point temperature experiment. The data points can be seen with a black x marks and the solid lines are the best-fit lines. The reflected frequency center contains the least amount of error and later will be proven to be the most reliable indicator. Meanwhile, no visible correlation was present for the reflected amplitude as seen in FIG. 18. FIG. 18 shows a plot of temperature vs. reflected amplitude for the test with a best fit line drawn through black x datapoints.

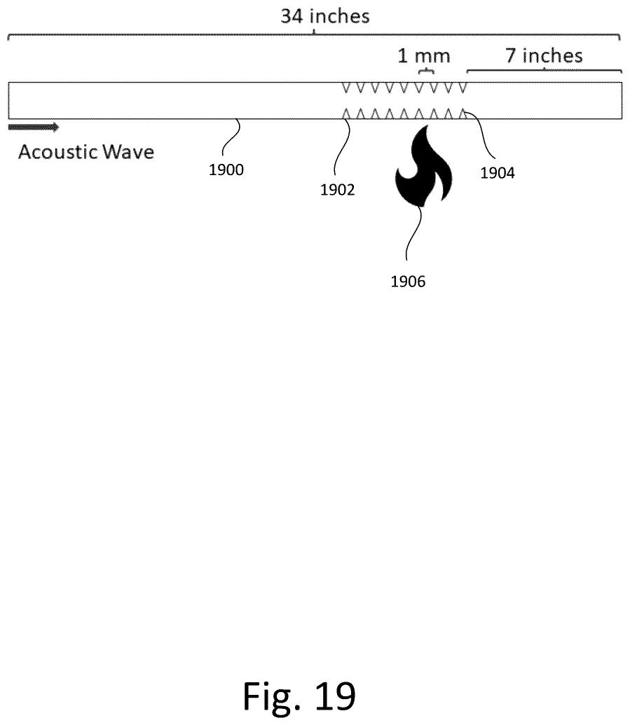

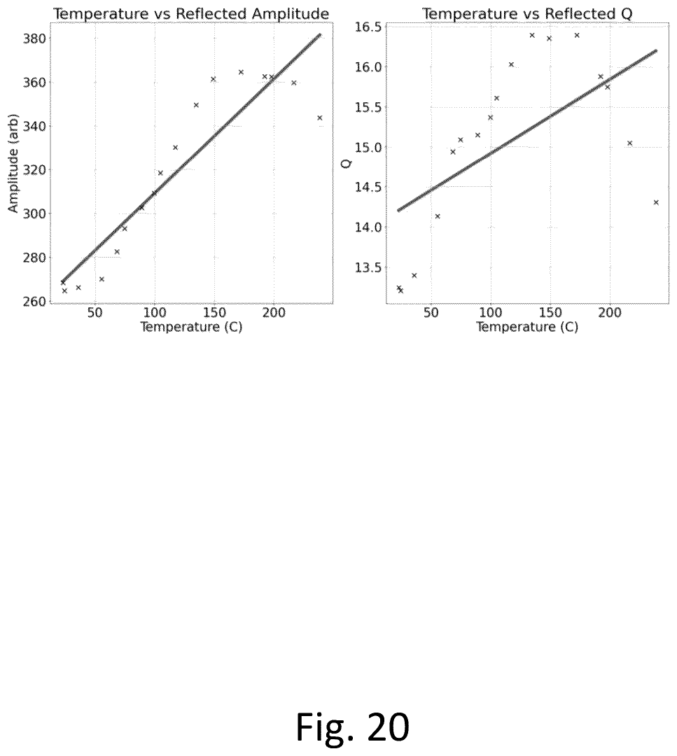

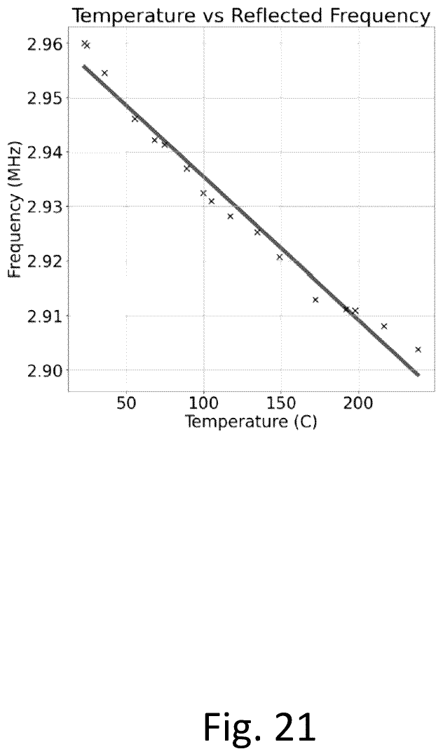

Another frequency that deemed feasible was 3 MHz. By repeating the experiment described above with a different waveguide with 1 mm grating with 9 notches, single-point temperature measurement experiments were performed focusing around 3 MHz. FIG. 19 shows a schematic of the experiment. FIG. 19 shows an exemplary waveguide 1900 for the single point temperature experiment designed for a 3 MHz signal with a single grating 1902 with multiple notches 1904 and a heat source 1906. As a result of this experiment, it can be observed that a loose correlation between the temperature and Q factor and reflected amplitude of the signal. However, these correlations contain large amounts of error and cannot be used for temperature measurements. Furthermore, although previous experimentation showed a good correlation between the Q factor and the temperature, this experiment indicated that the temperature vs. Q factor correlation is not reliable, as shown in FIG. 20. FIG. 20 shows plots of temperature vs. reflected amplitude center and Q factor. It is clear that these quantities are not feasible for temperature measurements. Data points can be seen with black x marks with a red best-fit line. On the other hand, the same as the previous experiment targeting 1 MHz, the reflected frequency shows a linear correlation with the temperature with very little error as shown in FIG. 21. FIG. 21 is a plot of temperature vs. reflected frequency for the test targeting 1 MHz. Data points can be seen with black x marks with a red best-fit line. Therefore, it is safe to conclude that the reflected frequency from the gratings is a good indicator of temperature and can be used for temperature measurements.

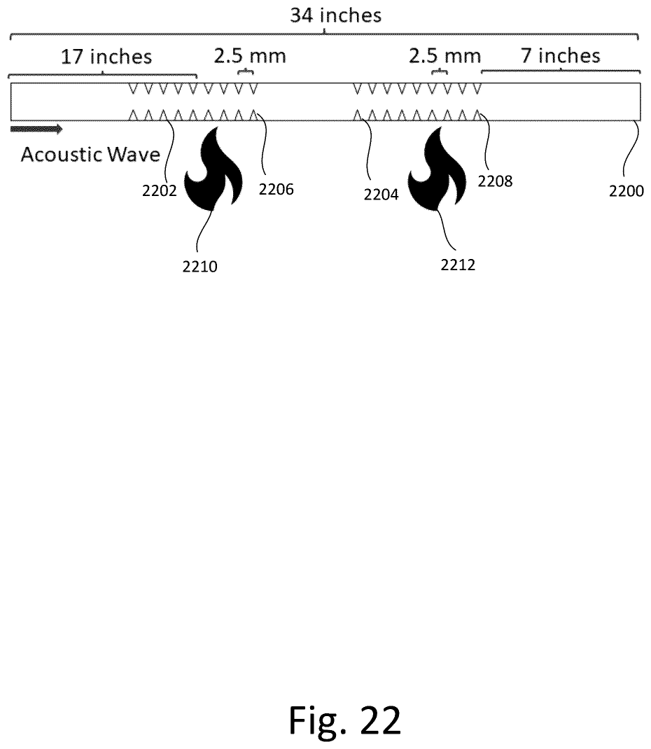

In order to test the feasibility of the multiple-point temperature measurement using our reflector grating approach, we tested the temperature of two points on the waveguide using two gratings at different locations. The experimental configuration closely resembles that of the single-point temperature measurement experiment, with the inclusion of an additional hotplate. Temperatures of gratings are monitored by K-type thermocouples placed between the gratings and the hot plates, and the temperatures are manually logged. Manual data collection and thermal stability of the hot plates introduced an uncertainty of less than 2° C. Similar to the single-point experiments, portions of the waveguide that were not directly in contact with the hotplates virtually remained at ambient temperature and were safe to handle. Preliminary experimentation and single-point temperature measurements yielded good results with 1 MHz frequency gratings before moving on to different gratings that target different frequencies. An experiment was performed with an exemplary waveguide 2200 with two identical grating patterns targeting 1 MHz frequency signals 2202, 2204 with notches 2206, 2208 and two heat sources 2210, 2212. An illustration of the setup can be found in FIG. 22. FIG. 22 is a schematic of an exemplary waveguide for the two-point temperature experiment designed with two 1 MHz gratings.

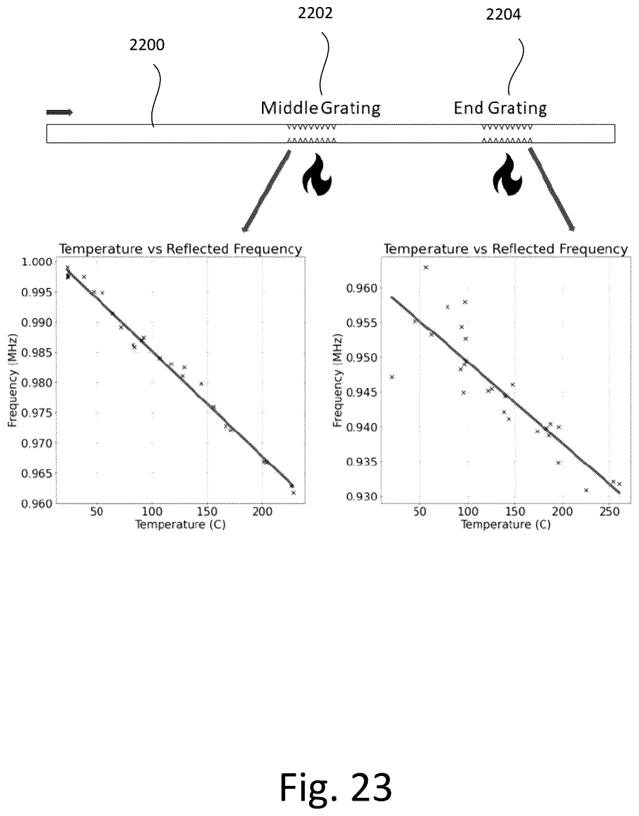

As established in previous experiments, the most reliable way to measure temperature is to track the reflected signal's center frequency around the grating's optimized frequency. Temperature vs. frequency obtained from the experiment can be found in FIG. 23. FIG. 23 shows plots of temperature vs. reflected frequency from two 1 MHz gratings on the same exemplary waveguide. Data points can be seen with black x marks with a solid best-fit line. The plots show that that both the middle 2204 and end 2204 gratings exhibit a strong linear correlation between temperature and frequency. Notably, the middle grating 2202, in particular, exhibits a low level of error, similar to single-point experiments. While the reflection from the end grating 2204 offers promising results, it is significantly more error-prone than the middle grating 2202 and the single-point measurements. This could be due to cross-talk between the middle 2202 and end 2204 grating. Especially since both of the gratings target the same frequency, transmitted signal quality from the middle grating 2202 may impact the reflected signal from the end grating 2204. Likewise, the middle grating 2202 will filter out the returning reflected signal from the end grating 2204, altering the frequency composition of the end grating response. Regardless, positive results were obtained for multi-point temperature measurements even with the gratings targeting the same wavelength.

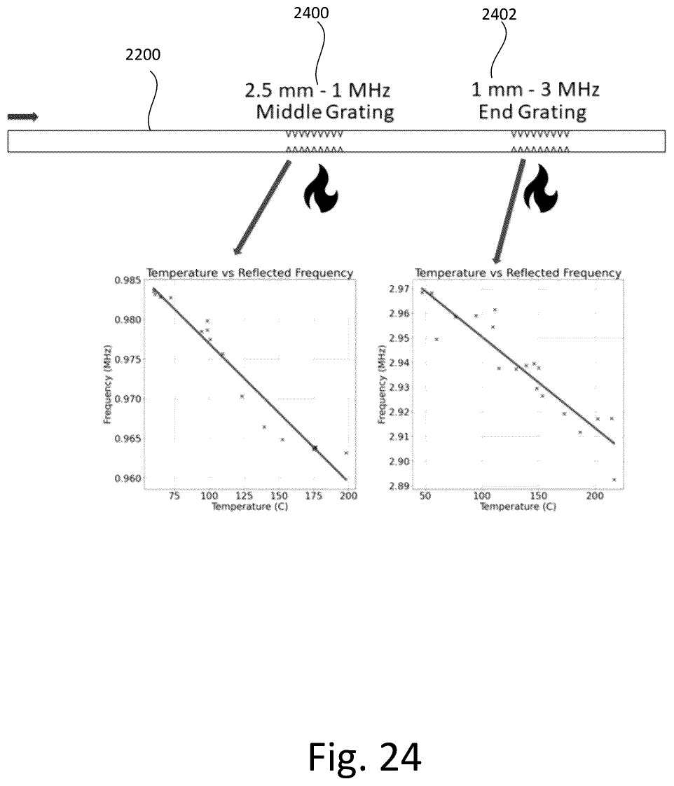

In a follow-up experiment, two different frequency gratings were used, targeting 1 MHz and 3 MHz signals. The same procedure as in the previous experiment was repeated and similar results were obtained. The results are presented in FIG. 24. FIG. 24 shows plots of temperature vs. reflected frequency from 1 MHz and 3 MHz gratings on the same waveguide 2200. A 1 MHz grating 2400 is placed at 17″ from the end of the 34″ waveguide 2200 and 3 MHz grating is placed 7″ from the end of the waveguide 2200. Data points can be seen with black x marks with a solid best-fit line. Both gratings showed a strong linear correlation between temperature and frequency, with a low level of error for the 1 MHz grating 2400, similar to the previous experiment's middle grating 2202. However, the 3 MHz grating 2402 exhibited a higher level of error, similar to the previous experiment's end grating 2204. The error is possibly due to cross-talk between the two gratings, as both gratings could potentially interfere with each other's signals. Despite the presence of some cross-talk effect, using this configuration, promising results were obtained for multi-point temperature measurements using different frequency gratings, indicating the potential for this technique to be used for temperature sensing in various applications.

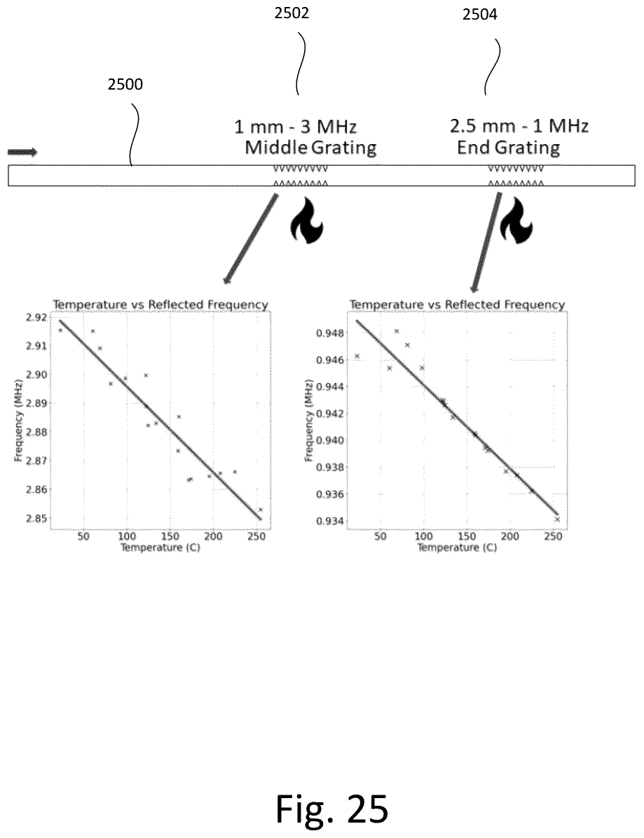

In order to decrease the cross-talk, switching the grating places could be helpful. Since the long wavelength signals get affected less by the non-targeted reflectors, they could be reflected from the later gratings on the waveguide, and short wavelength signals could be reflected from the earlier gratings on the waveguide. By switching the places of the 1 MHz grating and 3 MHz grating, a new exemplary waveguide was manufactured and tested using the previously used temperature test setup. The result of the experiment can be seen in the FIG. 25. FIG. 25 shows plots for temperature vs. reflected frequency from 3 MHz grating 2502 and 1 MHz grating 2504 on the new waveguide 2500. A 3 MHz grating 2502 is placed at 17″ from the end of the 34″ waveguide and 1 MHz grating 2504 is placed 7″ from the end of the waveguide. Data points can be seen with black x marks with a solid best-fit line. The effect of the crosstalk is significantly decreased for the consecutive wavelength and an overall higher accuracy is observed. Consistently to the previous results 3 MHz grating 2502 performs less accurate than 1 MHz grating 2504, possibly due to presence of the other longitudinal wave modes at the frequency, or the individual notch geometry being comparable to the wavelength.

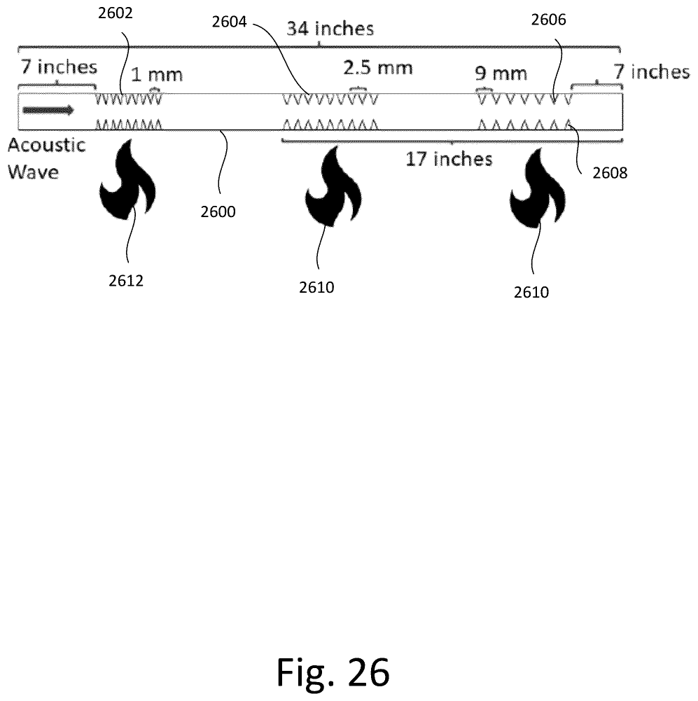

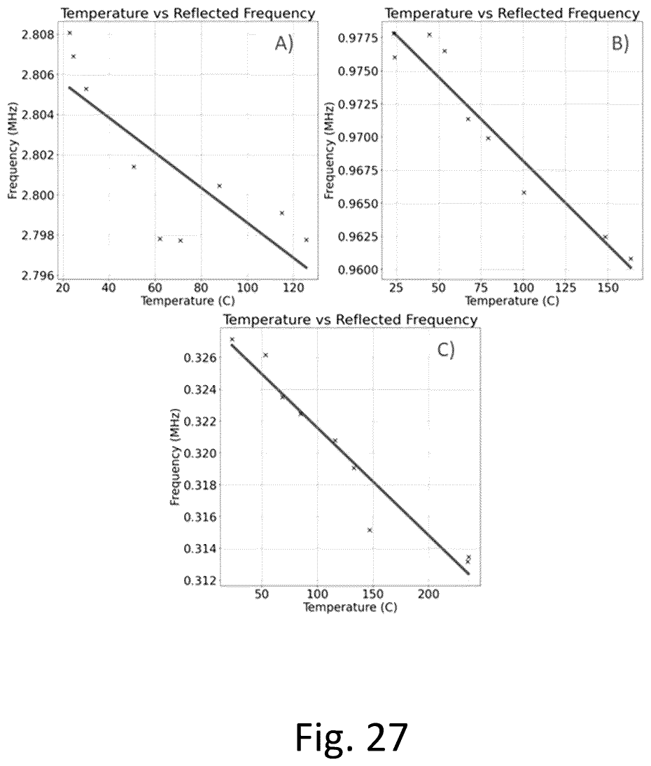

After performing successful two-point temperature measurement experiments, three-point temperature measurements were experimented with in an exemplary waveguide of the same length. The illustration of the waveguide can be found in FIG. 26. FIG. 26 is a schematic for the two-point temperature experiment with three different gratings 2602, 2604, and 2606 formed with notches 2608 on an exemplary waveguide 2600. The first grating 2602 was targeted at 3 MHz and placed 7 inches from the excited end of the waveguide; the second grating 2604 was targeted at 1 MHz and placed in the middle of the waveguide 2600, and the last grating 2606 was targeted at 300 kHz and located 7 inches from the end of the waveguide 2600. Since the 300 kHz grating required a much larger notch distance, only seven notches 2608 are used to form the grating. A similar experimental setup as previous experiments was utilized, utilizing two hotplates to heat 2610 each of gratings of the waveguide. Additionally, a soldering iron was introduced to provide heating 2612 for the first grating. All three grating temperatures are kept track of using k-type thermocouples recorded similarly to previous experiments. However, in this experiment achieving thermal stability proved to be a challenge, and in higher temperatures, the uncertainty of measurements was as high as 8° C. The result of the experiment can be seen in FIG. 27. FIG. 27 shows plots of temperature vs. reflected frequency from A) first grating (3 MHz), B) second grating (1 MHz), and C) third grating (300 kHz). Data points can be seen with black x marks with a solid best-fit line.

Overall, a good correlation was observed between the reflected wave packet frequency and the temperature. As can be seen from the FIG. 27, the errors in the first grating 2602 are significantly more than the other gratings in any other experiment. Being close to the excitation point made the signal from the first grating 2602 merge with the additional oscillations; therefore, the reflected wave packet could not be isolated precisely. In this experiment, the glue used for acoustic coupling could not be dried overnight; hence the duration of reverberations in the early signal was significantly higher and contributed to the challenge of isolating the first grating's wavepacket. Having a longer waveguide 2600 could make the measurement of multiple points significantly easier. Among all experiments, the highest considered frequency was 3 MHz, which contained multiple wave modes, and it performed the least effectively. Nevertheless, the multiple-point temperature measurement was successful overall.

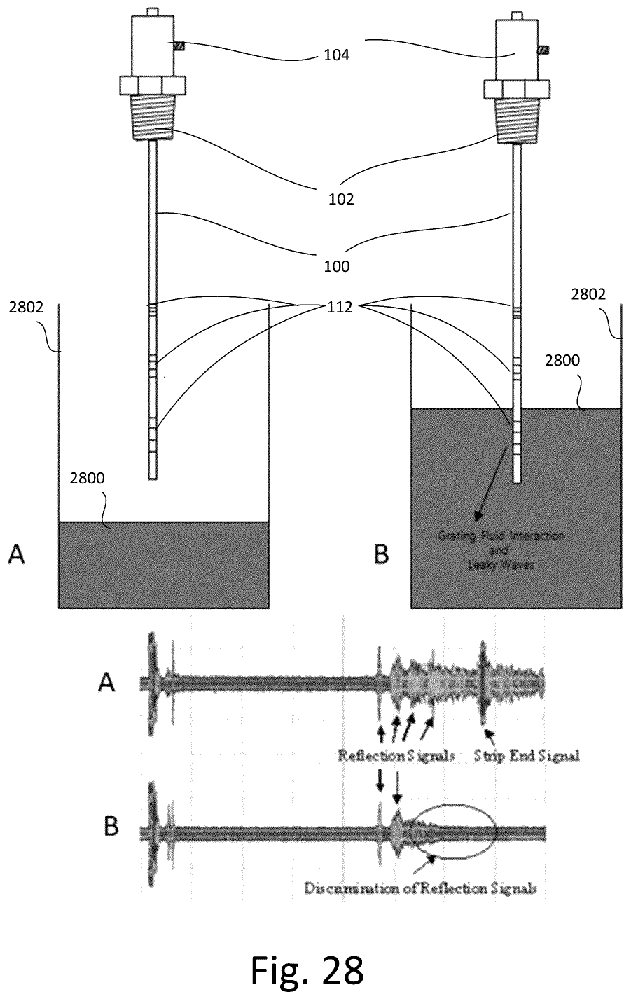

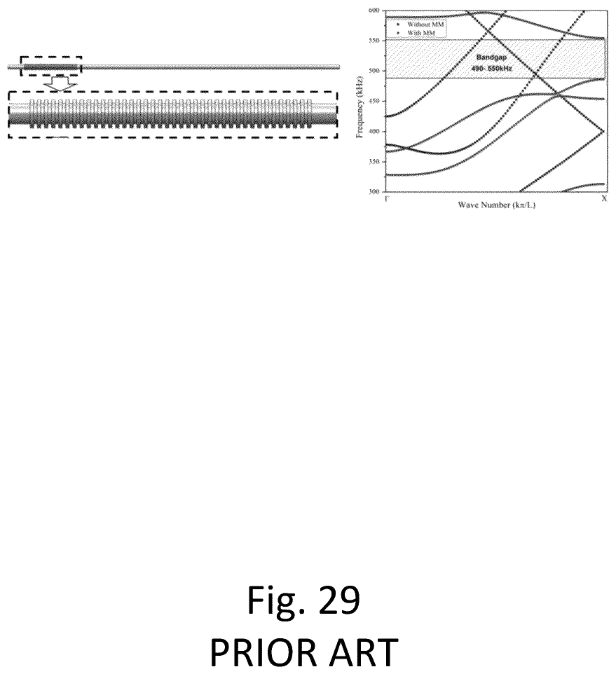

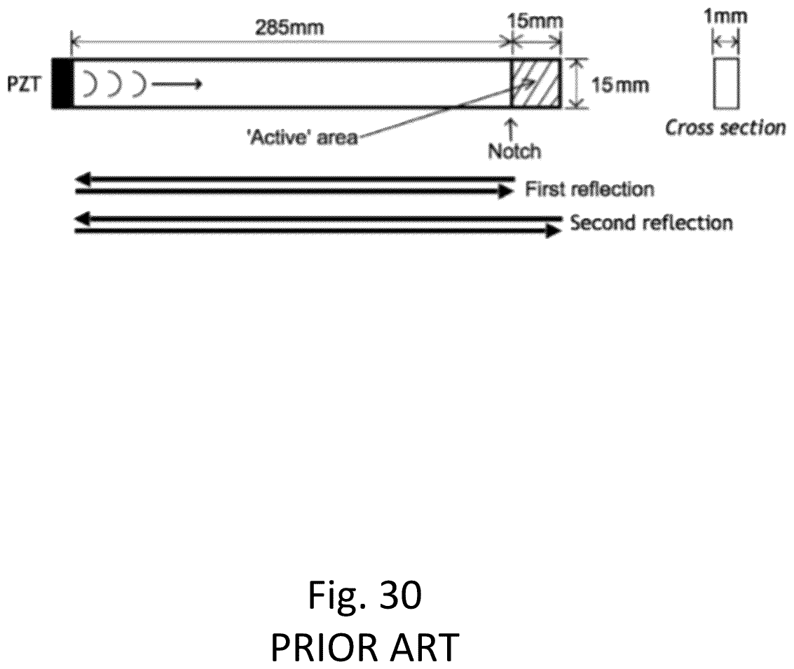

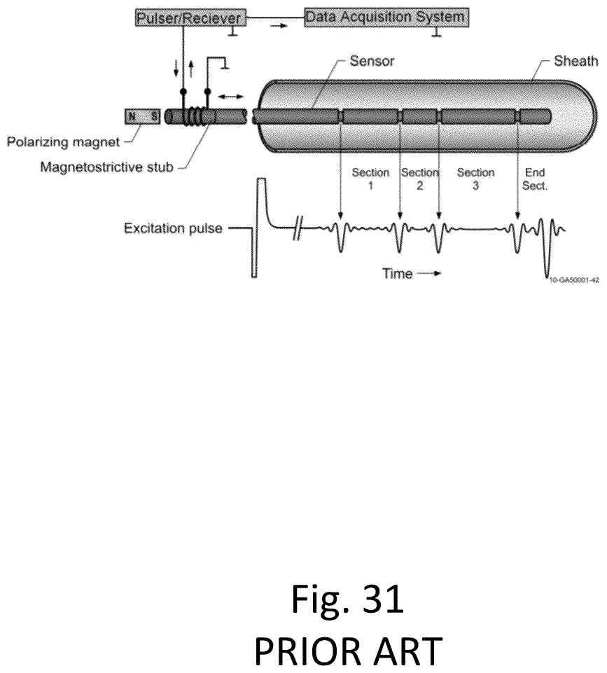

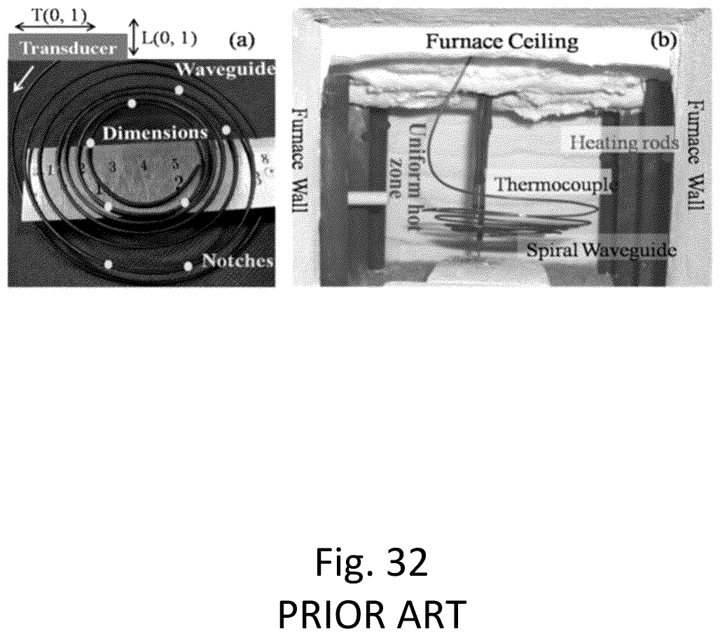

FIG. 28 shows an exemplary assembly of FIG. 1, with three sets of gratings, in a fluid interaction scenario. In scenario A, the waveguide 100 is above a fluid 2800 that is within a container 2802. Four frequency reflection signals and one strip end signal are detected that are shown in the graph below the container. In scenario B, the waveguide 100 is partially submerged in a fluid 2800, where the grating nearest the end of the waveguide is the only grating submerged. FIG. 28 illustrates the principle of an ultrasonic waveguide sensor assembly of the embodiments for fluid level measurement based on changes in detected reflection signals from gratings in the waveguide 100 before (A) and after (B) dipping into a fluid 2800. Dipping the waveguide 100 into the fluid 2800 alters the boundary conditions for the waveguide 100. A fluid boundary creates losses in the system and generates “leaky” waves. From the waveguide's perspective, leaky waves are dissipative, especially at higher frequencies. Without this fluid boundary around the waveguide 100, reflected signals would maintain a characteristic frequency/amplitude profile in echoes. After introducing the fluidic boundary to the waveguide 100, this frequency/amplitude behavior is altered. As frequency-selective reflectors have been implemented on the waveguide 100, each section of the waveguide 100 is tailored for different frequency signals. Thus, the dissipative behavior of different frequencies, and the altered frequency/amplitude behavior of the reflected signal, will indicate which portion of the waveguide 100 is currently submerged and therefore effectively measure the fluid level.

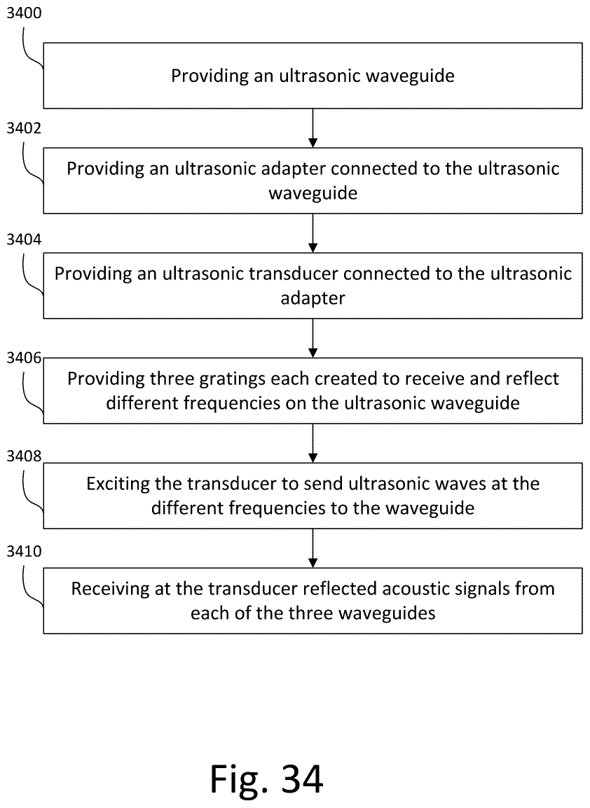

FIG. 34 is a flowchart of an exemplary method of the embodiments. At step 3400, the method provides an ultrasonic waveguide. At step 3402, the method provides an ultrasonic adapter connected to the ultrasonic waveguide. At step 3404, the method provides an ultrasonic transducer connected to the ultrasonic adapter. At step 3406, the method provides three gratings each created to receive and reflect different frequencies on the ultrasonic waveguide. At step 3408, the method excites the transducer to send ultrasonic waves at the different frequencies to the waveguide. At step 3410, the method receives at the transducer reflected acoustic signals from each of the three waveguides.

The numerous advantages of the embodiments are described as follows. The embodiments can be manufactured exclusively with components that are resilient to radiation. Although the waveguide and adapter in one embodiment can be made of stainless steel, materials used in the ultrasonic transducer housing design can be stainless steel and ceramics, which are often used in the nuclear industry. For example, stainless steel 316/316L/304 is used in making nuclear waste casks. Similarly, the piezoelectric element used here will also be of high radiation tolerance, such as AlN, ZnO, LiNbO₃, etc. The choice of these radiation-tolerant materials for the UMTS provides it with a long operation life. The proposed UMTS will be easy to install. The preferred method will be to use NPT connection as it allows leak-proof high-pressure operations. The installation will simply require mounting the UMTS on the subject surface using screws, and removing the screws to take it off. The UMTS will be designed as a modular unit where the length of the waveguide and material can be changed depending on the application requirements. The same is true for the REUT piezoelectric. The only component that needs to be upgraded in the REUT is the piezoelectric element and it can be changed at will by the operator based on the application area, radiation level, and the desired frequency of operation. The proposed UMTS will be compatible with existing systems as NPT connectors are widely used. Along with physical compatibility, the REUT used in UMTS design can be interrogated by COTS ultrasonic pulser receiver unit to interrogate the UMTS system. This will enable operators to maximize the potential of UMTS. However, dedicated electronics for UMTS system will be developed to achieve its best performance level. The only element which can possibly degrade in UMTS unit is the piezoelectric element in REUT for generation and reception of ultrasonic waves. REUT is made using piezoelectric material with high resilience to radiation. Once REUT is installed, the system will not require any maintenance. Therefore, the maintenance cost of the REUT will be minimal. In summary, our proposed UMTS development takes advantage of REUT technology and it will be made using materials resilient to radiation and widely used in nuclear systems, such as stainless steel 306. In simple words, the proposed technology to develop a UMTS will enable precise, valuable, and accurate multi-point ultrasonic temperature measurements with an extended operating life that will reduce sensor maintenance and the related costs, which may find applications in process monitoring in nuclear systems. The development of UMTS helps in increasing our confidence in nuclear reactor operation by helping the development of a more reliable feedback control system to control and improve the performance. Due to these advantages, UMTS can also find applications in non-nuclear systems having harsh operating conditions, such as high temperature and corrosive environment.

While the invention has been described with a certain degree of particularity, it is manifest that many changes may be made in detail of construction and the arrangement of components without departing from the spirit and scope of this disclosure. The present embodiment is to be considered as an exemplification of the invention and is not intended to limit the invention to the specific embodiments herein illustrated by the figures or description above.

What is claimed is:

1. An apparatus for distributed physical parameter measurements of a surrounding environment, comprising:
a waveguide with an elongated body configured with three gratings along the body,
wherein each of the three gratings is configured to fully or partially reflect a acoustic wave on the waveguide at a different frequency than the other gratings of the three gratings.

2. The apparatus of claim 1, wherein each of the three gratings comprises discontinuities in the grating configured to reflect one or more frequencies of acoustic waves.

3. The apparatus of claim 2, wherein each of the discontinuities for each of the three gratings has an internal geometry configured according to fractions of an acoustic wave's frequency and corresponding wavelength.

4. The apparatus of claim 1, further comprising:
an ultrasonic transducer configured to generate acoustic waves and convert incident acoustic energy into electrical signals; and
an ultrasonic adapter, operationally connected to the ultrasonic transducer and the waveguide, configured to facilitate an acoustic wave transfer between the waveguide and the transducer and to perform required acoustic wave conversions.

5. The apparatus of claim 4, further comprising:
an interrogation unit. operationally connected to the ultrasonic transducer, configured to excite acoustic waves from the ultrasonic transducer for transmission to the waveguide.
